(19) United States
(12) Patent Application Publication
(10) Pub. No.: US 2024/0152065 A1
(43) Pub. Date: May 9, 2024

(54) RESIN PARTICLES, TONER, METHOD FOR PRODUCING RESIN PARTICLES, METHOD FOR PRODUCING TONER, DEVELOPER, TONER STORAGE UNIT, AND IMAGE FORMING APPARATUS

(71) Applicants: Junichi Watanabe, Shizuoka (JP); Yuka Mizoguchi, Shizuoka (JP); Kohsuke Satoh, Shizuoka (JP); Toshihiko Sugiyama, Shizuoka (JP)

(72) Inventors: Junichi Watanabe, Shizuoka (JP); Yuka Mizoguchi, Shizuoka (JP); Kohsuke Satoh, Shizuoka (JP); Toshihiko Sugiyama, Shizuoka (JP)

(73) Assignee: Ricoh Company, Ltd., Tokyo (JP)

(21) Appl. No.: 18/549,958

(22) PCT Filed: Feb. 28, 2022
(86) PCT No.: PCT/JP2022/008470

§ 371 Date: Sep. 11, 2023

(30) Foreign Application Priority Data
Mar. 24, 2021 (JP) 2021-049691
Nov. 9, 2021 (JP) 2021-182567

(51) Int. Cl. G03G 9/087; G03G 9/08

(52) U.S. Cl. CPC G03G 9/08755; G03G 9/0804; G03G 9/08782; G03G 2215/0604

(57) ABSTRACT

Resin particles each include a crystalline polyester resin, an amorphous polyester resin, a release agent, and a colorant. The crystalline polyester resin includes an acid component and an alcohol component as constitutional units, and the acid component of the crystalline polyester resin includes plant-derived dicarboxylic acid having 12 or less carbon atoms. The crystalline polyester resin is present as domains in a matrix of the amorphous polyester resin within each resin particle, an average major axis of the domains of the crystalline polyester resin is 2.0 micrometers or less, and an average aspect ratio (major axis/minor axis) of the domains is 4.0 or greater. The resin particles have a carbon radioisotope ¹⁴C concentration of 5.4 pMC or greater.

### TECHNICAL FIELD

The present disclosure relates to resin particles, a toner, a method for producing resin particles, a method for producing a toner, a developer, a toner storage unit, and an image forming apparatus.

### BACKGROUND ART

Carbon neutrality is a term used associated with biomass materials typically formed of organic materials. Once a biomass material is burned, carbon dioxide is released.

Carbon contained in the carbon dioxide is derived from carbon dioxide absorbed from the atmosphere in the process of photosynthesis carried out during growth of a plant constituting the biomass material. Therefore, it is considered that an amount of carbon dioxide in the atmosphere is not increased as a whole even when the biomass material is used. Such characteristics are referred to as carbon neutrality.

In the conventional art, constitutional materials of a toner, particularly a binder resin, are dependent almost only on fossil resources. It is considered that carbon dioxide generated when a toner and printed images are discarded are vaporized to cause global warming. Moreover, a shift from use of fossil resources that are limited resources to use of renewable resources that are biomass resources is considered as a shift to continuously renewable resources because living creatures are composed of solar energy, water, and carbon dioxide. Therefore, the shift to use of renewable resources is desired technology.

Examples of constitutional materials of a toner obtained from such renewable resources include release agents, such as carnauba wax, and candelilla wax.

The release agent is blended to a toner in order to impart a release function during fixing, and a blended amount of the release agent is typically about several percent by mass. Therefore, use of the renewable resource as the release agent alone cannot satisfy carbon neutrality at all.

Meanwhile, use of a resin using renewable resources, such as polylactic acid (PLA) and a rosin compound, as a binder resin of a toner has been considered. For example, (1) a toner including PLA obtained through direct dehydration condensation (see PTL 1), (2) a toner including PLA having a modified terminal (see PTL 2), and (3) a toner including a polyester resin using methacrylic acid-modified rosin as a monomer (see PTL 3) have been proposed.

In order to exhibit functions as a toner, basic properties of a toner, such as low temperature fixability and low adhesion, are important.

PTL 4 discloses that a toner having excellent low temperature fixability can be provided by arranging crystalline polyester from a surface of a toner particle towards an inner side of the toner particle with the crystalline polyester having the large maximum major axis and sharp shapes.

PTL 5 discloses that a toner having low adhesion is provided by forming toner particles into flat shapes.

### CITATION LIST

### Patent Literature

PTL 1: Japanese Patent No. 3343635
PTL 2: Japanese Patent No. 2909873
PTL 3: Japanese Patent No. 5473252
PTL 4: Japanese Patent No. 5984528
PTL 5: Japanese Unexamined Patent Application Publication No. 2018-072454

### SUMMARY OF INVENTION

### Technical Problem

However, it is currently difficult to achieve use of renewable resources to contribute to carbon neutrality, and to satisfy desired toner properties, such as low temperature fixability and cleaning performance (low adhesiveness) at the same time

The present disclosure has an object to provide resin particles that can significantly contribute towards carbon neutrality, and can achieve desirable low temperature fixability and cleaning performance.

### Solution to Problem

According to one aspect of the present disclosure, resin particles each include a crystalline polyester resin, an amorphous polyester resin, a release agent, and a colorant. The crystalline polyester resin includes an acid component and an alcohol component as constitutional units. The acid component includes plant-derived dicarboxylic acid having 12 or less carbon atoms. The crystalline polyester resin is present as domains in a matrix of the amorphous polyester resin within each resin particle. An average major axis of the domains of the crystalline polyester resin is 2.0 micrometers or less. An average aspect ratio (major axis/minor axis) of the domains is 4.0 or greater. The resin particles have a carbon radioisotope ¹⁴C concentration of 5.4 pMC or greater.

### Advantageous Effects of Invention

The present disclosure can provide resin particles that can significantly contribute towards carbon neutrality, and can achieve desirable low temperature fixability and cleaning performance.

### BRIEF DESCRIPTION OF DRAWINGS

FIG. 1 is a view illustrating a crystalline polyester resin present inside a resin particle.

FIG. 2 is a schematic structural view illustrating an example of the image forming apparatus according to the embodiment of the present disclosure.

FIG. 3 is a schematic structural view illustrating another example of the image forming apparatus according to the embodiment of the present disclosure.

FIG. 4 is a schematic structural view illustrating another example of the image forming apparatus according to the embodiment of the present disclosure.

FIG. 5 is an enlarged partial view of FIG. 4.

FIG. 6 is a schematic structural view illustrating an example of a process cartridge.

### DESCRIPTION OF EMBODIMENTS

The resin particles, toner, method for producing resin particles, method for producing a toner, developer, toner storage unit, and image forming apparatus of the present disclosure will be described with reference to drawings hereinafter. The present disclosure is not limited to the following embodiments, and the embodiments may be changed within the range a person skilled in the art can arrive, such as change to another embodiment, addition, modification, deletion, and any of these embodiments may be included within the scope of the present disclosure as long as the embodiment has the function and effect of the present disclosure.

The resin particles of the present disclosure are suitably used for a toner. A toner is obtained by adding external additives to the resin particles.

A toner using the resin particles of the present disclosure as toner base particles will be described, and the resin particles will be described in the section of “Toner base particles” below.

(Toner)

The carbon radioisotope ¹⁴C concentration (may be referred to as “¹⁴C concentration” hereinafter) in the toner is 5.4 pMC or greater, and preferably 10.8 pMC or greater.

“pMC (percent modern carbon)” is one of units representing a ¹⁴C concentration, and is represented as a ratio (%) of the ¹⁴C concentration of a sample relative to the ¹⁴C concentration of the standard sample of 1950AD, when the ¹⁴C concentration of the standard sample is determined as 100%.

When the ¹⁴C concentration is less than 5.4 pMC, the biomass level is low, and the object of the present disclosure may not be achieved.

The ¹⁴C concentration is represented by the biomass level according to the following formula.

Biomass level (%)=¹⁴C concentration(pMC)×0.935

The ¹⁴C concentration being 5.4 pMC or greater means that the biomass level is 5% or greater, and is a desired concentration considering carbon neutrality. The ¹⁴C concentration is more preferably 20% or greater, and even more preferably 40% or greater.

The ¹⁴C concentration indicates what proportion of the carbon is plant-derived carbon within the carbon element component of petrochemicals including carbon. The ¹⁴C concentration in the carbon elements of the petrochemical can be measured, for example, according to ASTM-D6866 that is the ASTM standards of ASTM International.

The ¹⁴C is present in nature (in the atmosphere), and is taken into a plant when the plant carries out photosynthesis. The ¹⁴C concentration in CO₂ of the atmosphere and the ¹⁴C concentration in carbon elements of the organic component of the plant are equivalent to each other (107.5 pMC).

Once the plant stops the life activity and stops taking carbon into the system through photosynthesis, the ¹⁴C concentration of the plant starts decreasing according to the half-life of ¹⁴C that is 5,730 years.

Since several ten thousand years to several hundred million years have passed since the end of life activity of a living creature constituting a fossil resource, ¹⁴C is hardly detected from the fossil resource.

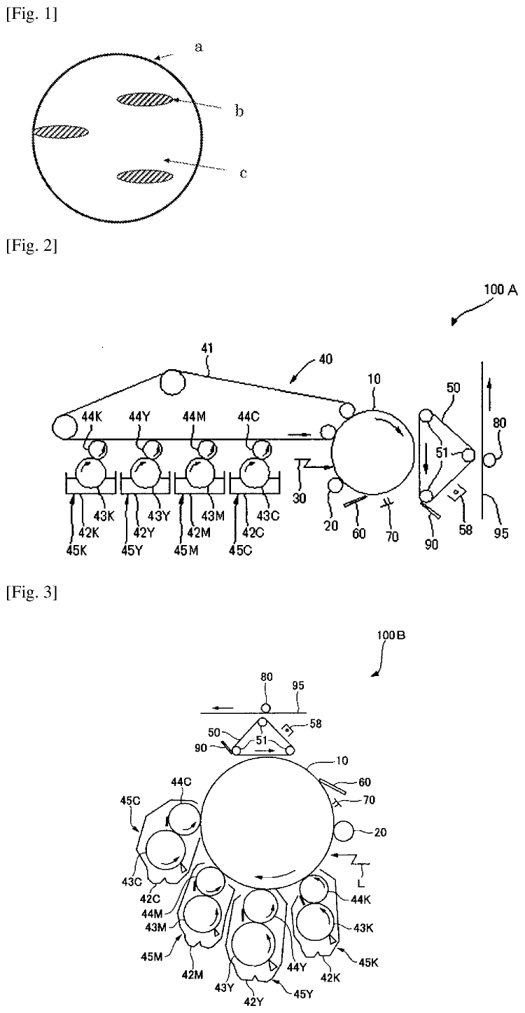

The toner includes a crystalline polyester resin. The crystalline polyester resin include an acid component as a constitutional unit. The acid component of the crystalline polyester resin is plant-derived C12 or less dicarboxylic acid. The crystalline polyester resin is present as domains (b) in a matrix of the amorphous polyester resin (c) within each of the resin particles (a), as illustrated in FIG. 1. A major axis of the domain of the crystalline polyester resin is 2.0 micrometers or less, and an aspect ratio (major axis/minor axis) of the domain of the crystalline polyester resin is 4.0 or greater.

The present disclosure can provide a toner that can significantly contribute towards carbon neutrality, and can achieve desirable low temperature fixability and cleaning performance at the same time. Moreover, preferable embodiments of the present disclosure can significantly contribute towards carbon neutrality, can achieve desirable low temperature fixability and cleaning performance at the same time, and can improve heat resistant storage stability.

The toner of the present disclosure includes toner base particles and external additives. The toner base particles each include a crystalline polyester resin, an amorphous polyester resin, a release agent, and a colorant.

A structural example of an embodiment of the toner including the toner base particles and the external additives will be described.

<Toner Base Particles (Resin Particles)>

The toner base particles each include a crystalline polyester resin, an amorphous polyester resin, a release agent, and a colorant. The toner base particles may further include other components according to the necessity.

«Crystalline Polyester Resin»

The crystalline polyester resin (may be referred to as a “crystalline polyester resin C” hereinafter) has high crystallinity, and thus has thermofusion properties that viscosity thereof drastically changes at around a fixing onset temperature.

Since the crystalline polyester resin C having the above-described properties and the amorphous polyester resin are used in combination, a toner having excellent heat resistant storage stability and low temperature fixability can be obtained. By the crystalline polyester resin C and the amorphous polyester resin in combination, for example, excellent heat resistant storage stability can be secured up to just below the melt onset temperature owing to crystallinity of the crystalline polyester resin C, and drastic reduction in viscosity (sharp melting) is caused at the melt onset temperature owing to melting of the crystalline polyester resin C. As a result of sharp melting, the crystalline polyester resin C becomes compatible with the below-described amorphous polyester resin B, and the viscosity is drastically reduced. Therefore, excellent fixing can be performed.

Moreover, an excellent release width (a difference between the minimum fixing temperature and hot offset onset temperature) can be achieved.

The crystalline polyester resin C is obtained with polyvalent alcohol and polyvalent carboxylic acid (e.g., polyvalent carboxylic acid, polyvalent carboxylic acid anhydride, and polyvalent carboxylic acid ester) or a derivative thereof.

In the present disclosure, as described above, the crystalline polyester resin C is a polyester resin obtained from polyvalent alcohol and polyvalent carboxylic acid (e.g., polyvalent carboxylic acid, polyvalent carboxylic acid anhydride, and polyvalent carboxylic acid ester) or a derivative thereof. A modified polyester resin, such as a below-described prepolymer and a resin obtained through a crosslink reaction and/or an elongation reaction of the prepolymer is not classified as the crystalline polyester resin C.

-Polyvalent Alcohol-

The polyvalent alcohol is not particularly limited, and may be appropriately selected depending on the intended purpose. Examples of the polyvalent alcohol include diol, and trivalent or higher alcohol. Examples of the diol include saturated aliphatic diol. Examples of the saturated aliphatic diol include straight-chain saturated aliphatic diol, and branched-chain saturated aliphatic diol. Among the above-listed examples, straight-chain saturated aliphatic diol is preferable, straight-chain saturated aliphatic diol having 2 carbon atoms or more but 12 carbon atoms or less is preferable is more preferable, and straight-chain saturated aliphatic diol having 2 carbon atoms or more but 8 carbon atoms or less is even more preferable. When the saturated aliphatic diol has a branched structure, a resultant crystalline polyester resin C has low crystallinity, leading to a low melting point. When the number of carbon atoms in the saturated aliphatic diol is greater than 12, materials for practical use are readily available. The number of carbon atoms in the saturated aliphatic diol is more preferable 12 or less.

Examples of the saturated aliphatic diol include ethylene glycol, 1,3-propanediol,

1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-eicosanedecanediol. Among the above-listed examples, ethylene glycol, 1,4-butanediol, 1,6-hexanediol, 1,8-octanediol, 1,10-decanediol, and 1,12-dodecanediol are preferable because the resultant crystalline polyester resin C has high crystallinity and exhibits excellent sharp-melt properties.

Examples of the trivalent or higher alcohol include glycerin, trimethylolethane, trimethylolpropane, and pentaerythritol.

The above-listed examples may be used alone or in combination.

-Polyvalent Carboxylic Acid-

Examples of the dicarboxylic acid include: saturated aliphatic dicarboxylic acid, such as oxalic acid, malonic acid, succinic acid, glutaric acid, sebacic acid, and dodecanedioic acid; unsaturated aliphatic dicarboxylic acid, such as fumaric acid, and maleic acid; and aromatic dicarboxylic acid, such as terephthalic acid.

The above-listed examples may be used alone or in combination.

The dicarboxylic acid is preferably a plant-derived C12 or less saturated aliphatic dicarboxylic acid. Since the dicarboxylic acid is plant-derived dicarboxylic acid, contribution to carbon neutrality. When the number of carbon atoms of the saturated aliphatic dicarboxylic acid is greater than 12, desirable compatibility to the amorphous polyester resin cannot be obtained, the aspect ratio of the crystalline polyester resin becomes low, and low temperature fixability becomes insufficient because of the reasons described below. Moreover, the saturated aliphatic has an effect of facilitating recrystallization of the crystalline polyester resin, increasing an aspect ratio of the crystalline polyester resin, and improving low temperature fixability.

A melting point of the crystalline polyester resin C is not particularly limited, and may be appropriately selected depending on the intended purpose. The melting point of the crystalline polyester C is preferably 60° C. or higher but 80° C. or lower. When the melting point of the crystalline polyester resin C is 60° C. or higher, the crystalline polyester resin C does not melt at a low temperature, and therefore desirable heat resistant storage stability of a toner can be obtained. When the melting point thereof is 80° C. or lower, the crystalline polyester resin C is desirably melted by heat applied during fixing, and thus desirable low temperature fixability can be obtained.

A molecular weight of the crystalline polyester resin C is not particularly limited, and may be appropriately selected depending on the intended purpose. Considering that the crystalline polyester resin C having a sharp molecular weight distribution and a low molecular weight can impart excellent low temperature fixability to a resultant toner, and the toner has low heat resistant storage stability when a large amount of the low molecular weight component is included therein, the ortho-dichlorobenzene-soluble component of the crystalline polyester resin C preferably has the weight average molecular weight (Mw) of from 3,000 through 30,000, the number average molecular weight (Mn) of from 1,000 through 10,000, and a ratio Mw/Mn of from 1.0 through 10, as measured by GPC.

The weight average molecular weight (Mw) is more preferably from 5,000 through 15,000. The number average molecular weight (Mn) is more preferably from 2,000 through 10,000. The ratio Mw/Mn is more preferably from 1.0 through 5.0.

An acid value of the crystalline polyester resin C is not particularly limited, and may be appropriately selected depending on the intended purpose. Considering affinity between paper and the resin, the acid value of the crystalline polyester resin C is preferably 5 mgKOH/g or greater, and more preferably 10 mgKOH/g or greater, in order to achieve desired low temperature fixability. In order to improve hot offset resistance, the acid value is preferably 45 mgKOH/g or less.

A hydroxyl value of the crystalline polyester resin C is not particularly limited, and may be appropriately selected depending on the intended purpose. In order to achieve desired low temperature fixability and excellent charging characteristics, the hydroxyl value of the crystalline polyester resin C is preferably 0 mgKOH/g or greater but 50 mgKOH/g or less, and more preferably 5 mgKOH/g or greater but 50 mgKOH/g or less.

A molecular structure of the crystalline polyester resin C can be confirmed by solution or solid NMR spectroscopy, X-ray diffraction spectroscopy, GC/MS, LC/MS, or IR spectroscopy. As a simple method for confirming the molecule structure thereof, there is a method for detecting a compound having absorption, which is based on OCH (out plane bending) of olefin, at 965±10 cm⁻¹ or 990±10 cm⁻¹ in an infrared absorption spectrum thereof as the crystalline polyester resin C.

An amount of the crystalline polyester resin C is not particularly limited, and may be appropriately selected depending on the intended purpose. The amount of the crystalline polyester resin C is preferably from 3 parts by mass through 20 parts by mass, and more preferably from 5 parts by mass through 15 parts by mass, relative to 100 parts by mass of the toner. When the amount thereof is 3 parts by mass or greater, sharp-melt properties of a resultant toner can be improved because of the crystalline polyester resin C, and therefore desirable low temperature fixability is obtained. When the amount thereof is 20 parts by mass or less, degradation of heat resistant storage stability can be prevented, and moreover fogging of an image can be prevented. The amount of the crystalline polyester resin C within the more preferable range is advantageous because the resultant toner excels in both image quality and low-temperature fixability.

«<Amorphous polyester resin»>

The amorphous polyester resin is not particularly limited, and may be appropriately selected depending on the intended purpose. The amorphous polyester resin preferably includes an amorphous polyester resin A and an amorphous polyester resin B, which will be described hereinafter.

-Amorphous Polyester Resin A-

The amorphous polyester resin A is not particularly limited, and may be appropriately selected depending on the intended purpose. The amorphous polyester resin A preferably has a glass transition temperature (Tg) of −60° C. or higher but 20° C. or lower, more preferably −40° C. or higher but 20° C. or lower. Moreover, the amorphous polyester resin A is preferably obtained through a reaction between a non-linear reactive precursor and a curing agent.

Moreover, the amorphous polyester resin A preferably includes a urethane bond, or a urea bond, or both considering excellent adhesion to a recording medium, such as paper. Since the amorphous polyester resin A includes a urethane or a urea bond, the urethane bond or the urea bond behaves as a pseudo-crosslinking point to enhance elastic characteristics of the amorphous polyester resin A, and therefore heat resistant storage stability and hot offset resistance of a resultant toner improve.

--Non-Linear Reactive Precursor--

The non-linear reactive precursor is not particularly limited and may be appropriately selected depending on the intended purpose, as long as the non-linear reactive precursor is a polyester resin having a group that can react with the curing agent (may be referred to as a “prepolymer” hereinafter).

Examples of a group of the prepolymer that can react with the curing agent include a group that can react with an active hydrogen group. Examples of the group that can react with an active hydrogen group include an isocyanate group, an epoxy group, carboxylic acid, and an acid chloride group. Among the above-listed examples, an isocyanate group is preferable because a urethane bond or a urea bond can be introduced into the amorphous polyester resin.

The prepolymer is preferably a non-linear polymer. The non-linear polymer means a polymer having a branched structure imparted by trivalent or higher alcohol, or trivalent or higher carboxylic acid, or both.

Moreover, the prepolymer is preferably an isocyanate group-containing polyester resin.

---Isocyanate Group-Containing Polyester Resin---

The isocyanate group-containing polyester resin is not particularly limited, and may be appropriately selected depending on the intended purpose. Examples of the isocyanate group-containing polyester resin include a reaction product between an active hydrogen group-containing polyester resin and polyisocyanate. For example, the active hydrogen group-containing polyester resin can be obtained through polycondensation between diol, dicarboxylic acid, and trivalent or higher alcohol or trivalent or higher carboxylic acid, or both. The trivalent or higher alcohol and trivalent or higher carboxylic acid impart a branched structure to the isocyanate group-containing polyester resin.

----Diol----

The diol is not particularly limited, and may be appropriately selected depending on the intended purpose. Examples of the diol include: aliphatic diol, such as ethylene glycol, 1,2-propyleneglycol, 1,3-propyleneglycol, 1,4-butanediol, 3-methyl-1,5-pentanediol, 1,6-hexanediol, 1,8-octanediol, 1,10-decanediol, and 1,12-dodecanediol; oxyalkylene group-containing diol, such as diethylene glycol, triethylene glycol, dipropylene glycol, polyethylene glycol, polypropylene glycol, and polytetramethylene glycol; alicyclic diol, such as 1,4-cyclohexanedimethanol, and hydrogenated bisphenol A; alicyclic diol-alkylene oxide (e.g., ethylene oxide, propylene oxide, and butylene oxide) adducts; bisphenols, such as bisphenol A, bisphenol F, and bisphenol S; and bisphenol-alkylene oxide (e.g., ethylene oxide, propylene oxide, and butylene oxide) adducts. Among the above-listed examples, C4-C12 aliphatic diol is preferable. The above-listed diols may be used alone or in combination.

----Dicarboxylic Acid----

The dicarboxylic acid is not particularly limited, and may be appropriately selected depending on the intended purpose. Examples of the dicarboxylic acid include aliphatic dicarboxylic acid, and aromatic dicarboxylic acid. Moreover, anhydrides thereof, lower (C1-C3) alkyl esters thereof, or hydrogenated products thereof may be used.

The aliphatic dicarboxylic acid is not particularly limited, and may be appropriately selected depending on the intended purpose. Examples of the aliphatic dicarboxylic acid include succinic acid, adipic acid, sebacic acid, dodecanedioic acid, maleic acid, and fumaric acid.

The aromatic dicarboxylic acid is not particularly limited, and may be appropriately selected depending on the intended purpose. The aromatic hydrocarboxylic acid is preferably C8-C20 aromatic dicarboxylic acid. The C8-C20 aromatic dicarboxylic acid is not particularly limited, and may be appropriately selected depending on the intended purpose. Examples of the C8-C20 aromatic dicarboxylic acid include phthalic acid, isophthalic acid, terephthalic acid, and naphthalene dicarboxylic acid.

Among the above-listed examples, the dicarboxylic acid preferably includes plant-derived saturated aliphatic succinic acid, sebacic acid, or dodecanedionic acid.

Use of the plant-derived aliphatic dicarboxylic acid can improve carbon neutrality. The saturated aliphatic dicarboxylic acid has an effect of facilitating recrystallization of the crystalline polyester resin, and therefore use thereof can improve an aspect ratio of the domains of the crystalline polyester resin within the toner base particles and improve low temperature fixability of a resultant toner.

The above-listed dicarboxylic acids may be used alone or in combination.

----Trivalent or Higher Polyvalent Alcohol----

The trivalent or higher alcohol is not particularly limited, and may be appropriately selected depending on the intended purpose. Examples of the trivalent or higher alcohol include trivalent or higher aliphatic alcohol, trivalent or higher polyphenols, and trivalent polyphenol-alkylene oxide adducts.

Examples of the trivalent or higher aliphatic alcohol include glycerin, trimethylolethane, trimethylolpropane, pentaerythritol, and sorbitol.

Examples of the trivalent or higher polyphenols include trisphenol PA, phenol novolac, and cresol novolac.

Examples of the trivalent or higher polyphenol-alkylene oxide adduct include trivalent or higher polyphenol-alkylene oxide (e.g., ethylene oxide, propylene oxide, and butylene oxide) adducts.

The amorphous polyester resin A preferably includes trivalent or higher aliphatic alcohol as a constitutional unit.

Since the amorphous polyester resin A includes trivalent or higher aliphatic alcohol as a constitutional component, the amorphous polyester resin A has a branched structure in a molecular skeleton thereof, and a molecular chain thereof forms a three-dimensional network structure. Therefore, the amorphous polyester resin A has rubber-like characteristics that the amorphous polyester resin A deforms at a low temperature but does not flow. Accordingly, a resulting toner can maintain heat resistant storage stability and hot offset resistance.

The amorphous polyester resin A may be able to use trivalent or higher carboxylic acid or epoxy as a crosslink component. When the carboxylic acid is used as the crosslink component, the compound including such a crosslink component is often an aromatic compound, or an ester bond density of the crosslink site is high, and therefore sufficient gloss of a fixed image formed by heat fixing the toner may not be obtained. When a crosslinking agent, such as epoxy, is used, a cross-linking reaction is performed after polymerization of polyester. Therefore, it is difficult to control a distance between crosslink points thus target viscoelasticity cannot be obtained. As the epoxy tends to react with oligomers during formation of polyester to form sites having high crosslink density, a fixed image tends to be uneven to impair glossiness or image density.

----Trivalent or Higher Carboxylic Acid----

The trivalent or higher carboxylic acid is not particularly limited, and may be appropriately selected depending on the intended purpose. Examples of the trivalent or higher carboxylic acid include trivalent or higher aromatic carboxylic acid. Moreover, anhydrides thereof, lower (C1-C3) alkyl esters thereof, or hydrogenated products thereof may be used.

The trivalent or higher aromatic carboxylic acid is C9-C20 trivalent or higher aromatic carboxylic acid. Examples of C9-C20 trivalent or higher aromatic carboxylic acid include trimellitic acid, and pyromellitic acid.

----Polyisocyanate----

The polyisocyanate is not particularly limited, and may be appropriately selected depending on the intended purpose. Examples of the polyisocyanate include diisocyanate, and trivalent or higher isocyanate.

Examples of the diisocyanate include aliphatic diisocyanate, alicyclic diisocyanate, aromatic diisocyanate, aromatic aliphatic diisocyanate, isocyanurate, and products obtained by blocking the above-listed polyisocyanates with a phenol derivative, oxime, or caprolactam.

The aliphatic diisocyanate is not particularly limited, and may be appropriately selected depending on the intended purpose. Examples of the aliphatic diisocyanate include tetramethylene diisocyanate, hexamethylene diisocyanate, 2,6-diisocyanatocaproic acid methyl ester, octamethylene diisocyanate, decamethylene diisocyanate, dodecamethylene diisocyanate, tetradecamethylene diisocyanate, trimethylhexane diisocyanate, and tetramethylhexane diisocyanate.

The alicyclic diisocyanate is not particularly limited, and may be appropriately selected depending on the intended purpose. Examples of the alicyclic diisocyanate include isophorone diisocyanate, and cyclohexyl methane diisocyanate.

The aromatic diisocyanate is not particularly limited, and may be appropriately selected depending on the intended purpose. Examples of the aromatic diisocyanate include tolylene diisocyanate, diisocyanatodiphenyl methane, 1,5-naphthylenediisocyanate, 4,4′-diisocyanatodiphenyl, 4,4′-diisocyanato-3,3′-dimethyldiphenyl, 4,4′-diisocyanato-3-methyldiphenylmethane, and 4,4′-diisocyanato-diphenylether.

The aromatic aliphatic diisocyanate is not particularly limited, and may be appropriately selected depending on the intended purpose. Examples of the aromatic aliphatic diisocyanate include α,α,α′,α′-tetramethylxylylenediisocyanate. The isocyanurate is not particularly limited, and may be appropriately selected

depending on the intended purpose. Examples of the isocyanurate include tris(isocyanatalkyl)isocyanurate, and tris(isocyanatocycloalkyl)isocyanurate.

The above-listed polyisocyanates may be used alone or in combination.

--Curing Agent--

The curing agent is not particularly limited as long as the curing agent can react with the non-linear reactive precursor to generate the amorphous polyester resin A, and may be appropriately selected depending on the intended purpose. Examples of the curing agent include an active hydrogen group-containing compound.

---Active Hydrogen Group-Containing Compound---

An active hydrogen group in the active hydrogen group-containing compound is not particularly limited, and may be appropriately selected depending on the intended purpose. Examples of the active hydrogen group include a hydroxyl group (e.g., an alcoholic hydroxyl group, and a phenolic hydroxyl group), an amino group, a carboxyl group, and a mercapto group. The above-listed examples may be used alone or in combination.

The active hydrogen group-containing compound is not particularly limited, and may be appropriately selected depending on the intended purpose. The active hydrogen group-containing compound is preferably any of amines because the amine can form a urea bond.

The amines are not particularly limited, and may be appropriately selected depending on the intended purpose. Examples of the amines include diamine, trivalent or higher amine, amino alcohol, aminomercaptan, amino acid, and any of the above-listed amines in which an amino group is blocked. The above-listed examples may be used alone or in combination.

Among the above-listed examples, diamine, and a mixture of diamine and a small amount of trivalent or higher amine are preferable.

The diamine is not particularly limited, and may be appropriately selected depending on the intended purpose. Examples of the diamine include aromatic diamine, alicyclic diamine, and aliphatic diamine. The aromatic diamine is not particularly limited, and may be appropriately selected depending on the intended purpose. Examples of the aromatic diamine include phenylene diamine, diethyltoluene diamine, and 4,4′-diaminodiphenylmethane.

The alicyclic diamine is not particularly limited, and may be appropriately selected depending on the intended purpose. Examples of the alicyclic diamine include 4,4′-diamino-3,3′-dimethyldicyclohexylmethane, diaminocyclohexane, and isophoronediamine. The aliphatic diamine is not particularly limited, and may be appropriately selected depending on the intended purpose. Examples of the aliphatic diamine include ethylene diamine, tetramethylene diamine, and hexamethylene diamine.

The trivalent or higher amine is not particularly limited, and may be appropriately selected depending on the intended purpose. Examples of the trivalent or higher amine include diethylene triamine, and triethylene tetramine.

Examples of the amino alcohol is not particularly limited, and may be appropriately selected depending on the intended purpose. Examples of the amino alcohol include ethanol amine, and hydroxyethylaniline.

The aminomercaptan is not particularly limited, and may be appropriately selected depending on the intended purpose. Examples of the aminomercaptan include aminoethylmercaptan, and aminopropylmercaptan.

The amino acid is not particularly limited, and may be appropriately selected depending on the intended purpose. Examples of the amino acid include amino propionic acid, and amino caproic acid.

The amine in which an amino group is blocked is not particularly limited, and may be appropriately selected depending on the intended purpose. Examples thereof include ketimine compounds and oxazoline compounds obtained by blocking an amino group with any of ketones, such as acetone, methyl ethyl ketone, and methyl isobutyl ketone.

In order to maintain Tg of the amorphous polyester resin A low to impart deformable characteristics at low temperatures, the amorphous polyester resin A includes a diol component as a constitutional component, and the diol component preferably includes C4-C12 aliphatic diol in the amount of 50% by mass or greater.

Moreover, the amorphous polyester resin A includes 50% by mass or greater of C4-C12 aliphatic diol relative to the entire alcohol component. When the amount of C4-C12 aliphatic diol in the entire alcohol component is 50% by mass or greater, Tg of the amorphous polyester resin A can be kept low, and deformable characteristics at low temperatures may be easily imparted.

The amorphous polyester resin A include a dicarboxylic acid component as a constitutional unit, and the dicarboxylic acid component preferably includes C4-C12 aliphatic dicarboxylic acid in the amount of 50% by mass or greater. When the amount of the C4-C12 aliphatic dicarboxylic acid is 50% by mass or greater, Tg of the amorphous polyester resin A can be kept low, and deformable characteristics at low temperatures may be easily imparted.

The weight average molecular weight of the amorphous polyester resin A is not particularly limited, and may be appropriately selected depending on the intended purpose. The weight average molecular weight of the amorphous polyester resin A as measured by gel permeation chromatography (GPC) is preferably 10,000 or greater but 1,000,000 or less, more preferably 10,000 or greater but 300,000 or less, and particularly preferably 10,000 or greater but 200,000 or less. When the weight average molecular weight of the amorphous polyester resin A is 10,000 or greater, a resultant toner is prevented from flowing at low temperatures to improve heat resistant storage stability. In addition, viscosity of a resultant toner is maintained at an appropriate level during melting to secure sufficient hot offset resistance.

A molecular structure of the amorphous polyester resin A can be confirmed by solution or solid NMR spectroscopy, X-ray diffraction spectroscopy, GC/MS, LC/MS, or IR spectroscopy. As a simple method for confirming the molecular structure thereof, there is a method for detecting a compound that does not have absorption, which is based on OCH (out plane bending) of olefin, at 965±10 cm⁻¹ or 990±10 cm⁻¹ in an infrared absorption spectrum thereof as the amorphous polyester resin.

An amount of the amorphous polyester resin A is not particularly limited, and may be appropriately selected depending on the intended purpose. The amount of the amorphous polyester resin A is preferably from 5 parts by mass through 25 parts by mass, and more preferably from 10 parts by mass through 20 parts by mass, relative to 100 parts by mass of the toner. When the amount of the amorphous polyester resin A is 5 parts by mass or greater, sufficient low temperature fixability and hot offset resistance can be obtained. When the amount thereof is 25 parts by mass or less, heat resistant storage stability is secured, and desired glossiness of an image is obtained after fixing. The amount of the amorphous polyester resin A within the more preferable range is advantageous because all of excellent low temperature fixability, hot offset resistance, and heat resistant storage stability are obtained.

-Amorphous Polyester Resin B-

The amorphous polyester resin B is preferably a linear polyester resin, and more preferably an unmodified polyester resin.

The unmodified polyester resin is a polyester resin obtained with polyvalent alcohol, and polyvalent carboxylic acid (e.g., polyvalent carboxylic acid, polyvalent carboxylic acid anhydride, and polyvalent carboxylic acid ester) or a derivative thereof. The unmodified polyester resin is a polyester resin that is not modified with an isocyanate compound etc. The amorphous polyester resin B is preferably free from a urethane bond and a urea bond.

The amorphous polyester resin B includes a dicarboxylic acid as a constitutional component, and the dicarboxylic acid component preferably includes terephthalic acid in the amount of 50 mol % or greater. The dicarboxylic acid comment including 50 mol % or greater of terephthalic acid is advantageous considering heat resistant storage stability.

Examples of the polyvalent alcohol include diol.

Examples of the diol include: bisphenol A (C2-C3) alkylene oxide (the average number of moles added: from 1 through 10) adducts, such as poly-oxypropylene(2.2)-2,2-bis(4-hydroxyphenyl)propane, and poly-oxyethylene(2.2)-2,2-bis(4-hydroxyphenyl)propane; ethylene glycol, and propylene glycol; hydrogenated bisphenol A; and hydrogenated bisphenol A (C2-C3) alkylene oxide (the average number of moles added from 1 through 10).

The above-listed examples may be used alone or in combination.

Examples of the polyvalent carboxylic acid dicarboxylic acid.

Examples of the dicarboxylic acid include adipic acid, phthalic acid, isophthalic acid, terephthalic acid, fumaric acid, maleic acid, and succinic acid substituted with a C1-C20 alkyl group or a C2-C20 alkenyl group (e.g., dodecenylsuccinic acid, and octylsuccinic acid).

Among the above listed examples, the dicarboxylic acid component preferably include a plant-derived saturated aliphatic succinic acid. Since the saturated aliphatic succinic acid is plant derived, carbon neutrality can be enhanced. The saturated aliphatics have an effect of facilitating recrystallization of the crystalline polyester resin, improves an aspect ratio of the crystalline polyester resin, and improves low temperature fixability.

The above-listed examples may be used alone or in combination.

For the purpose of adjusting an acid value and a hydroxyl value, the amorphous polyester resin B may include trivalent or higher carboxylic acid, or trivalent or higher alcohol, or both at a terminal of a molecular chain of the amorphous polyester resin B. Examples of the trivalent or higher carboxylic acid include trimellitic acid, pyromellitic acid, and acid anhydrides thereof.

Examples of the trivalent or higher alcohol include glycerin, pentaerythritol, and trimethylolpropane.

A molecular weight of the amorphous polyester resin B is not particularly limited, and may be appropriately selected depending on the intended purpose. The weight average molecular weight (Mw) of the amorphous polyester resin B as measured by gel permeation chromatography (GPC) is preferably from 3,000 through 10,000. The number average molecular weight (Mn) thereof is preferably from 1,000 through 4,000. The ratio Mw/Mn is preferably from 1.0 through 4.0.

When the molecular weight of the amorphous polyester resin B is the above-mentioned lower limit or greater, desirable heat resistant storage stability, and desirable durability of the toner against stress, such as stirring inside a developing device can be obtained. When the molecular weight of the amorphous polyester resin B is the above-mentioned upper limit or lower, viscoelasticity of the toner during melting is desirable, and thus desirable low temperature fixability can be obtained.

The weight average molecular weight (Mw) of the amorphous polyester resin B is more preferably from 4,000 through 7,000. The number average molecular weight (Mn) of the amorphous polyester resin B is more preferably from 1,500 through 3,000. The ratio Mw/Mn is more preferably from 1.0 through 3.5.

An acid value of the amorphous polyester resin B is not particularly limited, and may

be appropriately selected depending on the intended purpose. The acid value of the amorphous polyester resin B is preferably from 1 mgKOH/g through 50 mgKOH/g, and more preferably from 5 mgKOH/g through 30 mgKOH/g. When the acid value of the amorphous polyester resin B is 1 mgKOH/g or greater, a resultant toner tends to be negatively charged to improve affinity between the toner and the paper during fixing on the paper, leading to favorable low temperature fixability. When the acid value thereof is 50 mgKOH/g or less, desirable charge stability, especially charge stability against fluctuations of the environment, can be obtained.

A hydroxyl value of the amorphous polyester resin B is not particularly limited, and may be appropriately selected depending on the intended purpose. The hydroxyl value thereof is preferably 5 mgKOH/g or greater.

A glass transition temperature (Tg) of the amorphous polyester resin B is preferably 40° C. or higher but 80° C. or lower, and more preferably 50° C. or higher but 70° C. or lower. When the glass transition temperature is 40° C. or higher, sufficient heat resistant storage stability and sufficient durability of the toner against stress, such as stirring inside a developing device, can be obtained, and excellent anti-filming properties can be obtained. When the glass transition temperature is 80° C. or lower, the toner is sufficiently deformed by heat and pressure applied during fixing, and excellent low temperature fixability is obtained.

A molecular structure of the amorphous polyester resin B can be confirmed by solution or solid NMR spectroscopy, X-ray diffraction spectroscopy, GC/MS, LC/MS, or IR spectroscopy. As a simple method for confirming the molecular structure thereof, there is a method for detecting a compound that does not have absorption, which is based on OCH (out plane bending) of olefin, at 965±10 cm⁻¹ or 990±10 cm⁻¹ in an infrared absorption spectrum thereof as the amorphous polyester resin.

An amount of the amorphous polyester resin B is not particularly limited, and may be appropriately selected depending on the intended purpose. The amount of the amorphous polyester resin B is preferably from 50 parts by mass through 90 parts by mass, and more preferably from 60 parts by mass through 80 parts by mass, relative to 100 parts by mass of the toner. When the amount of the amorphous polyester resin B is 50 parts by mass or greater, dispersibility of the pigment and the release agent in the toner can be desirably maintained to prevent fogging or disturbance of an image. When the amount thereof is 90 parts by mass or less, the appropriate amounts of the crystalline polyester resin C and the amorphous polyester resin A are secured to maintain sufficient low temperature fixability. The amount of the amorphous polyester resin B within the more preferable range is advantageous because excellent image quality and low temperature fixability are both obtained.

In order to further improve low temperature fixability, the amorphous polyester resin A is preferably used in combination with the crystalline polyester resin C. In order to achieve both low temperature fixability and stability at high temperatures and high humidity, a glass transition temperature of the amorphous polyester resin A is preferably very low. Since the glass transition temperature of the amorphous polyester resin A is very low, the amorphous polyester resin A has characteristics that the amorphous polyester resin A deforms at a low temperature. Therefore, a resultant toner has characteristics that the toner deforms upon application of heat and pressure applied during fixing to easily adhere to paper at a low temperature. Since the reactive precursor has a non-linear molecular structure according one embodiment of the amorphous polyester resin A, the amorphous polyester resin A has a branched structure in a molecule skeleton and a molecular chain thereof has a three-dimensional network structure. Therefore, the amorphous polyester resin A has rubber-like characteristics that the amorphous polyester resin A deforms at a low temperature but does not flow. Accordingly, a resultant toner can maintain heat resistant storage stability and hot offset resistance.

When the amorphous polyester resin A has a urethane bond or urea bond having high cohesive energy, excellent adhesion of a resultant toner to a recording medium, such as paper, is obtained. Since the urethane bond or the urea bond behaves as a pseudo-cross-linking point to enhance elastic characteristics of the amorphous polyester resin A, heat resistant storage stability and hot offset resistance of a resultant toner improve.

Specifically, the toner of the present disclosure has very excellent low temperature fixability when the amorphous polyester resin A, the crystalline polyester resin C, and optionally another amorphous polyester resin B are used in combination. Since the amorphous polyester resin A having a glass transition temperature in a low temperature range, moreover, the toner can maintain desirable heat resistant storage stability and hot offset resistance even though the glass transition temperature of the toner is set lower than a glass transition temperature of a toner in the art, and the toner has excellent low temperature fixability because the toner has a low glass transition temperature.

«Colorant»

The colorant is not particularly limited, and may be appropriately selected depending on the intended purpose. Examples of the colorant include carbon black, a nigrosine dye, iron black, naphthol yellow S, Hansa yellow (10G, 5G, G), cadmium yellow, yellow iron oxide, yellow ocher, yellow lead, titanium yellow, polyazo yellow, oil yellow, Hansa yellow (GR, A, RN, R), pigment yellow L, benzidine yellow (G, GR), permanent yellow (NCG), Vulcan fast yellow (5G, R), tartrazine lake, quinoline yellow lake, anthrasan yellow BGL, isoindolinon yellow, red iron oxide, red lead, lead vermilion, cadmium red, cadmium mercury red, antimony vermilion, permanent red 4R, parared, fiser red, parachloroorthonitro aniline red, lithol fast scarlet G, brilliant fast scarlet, brilliant carmine BS, permanent red (F2R, F4R, FRL, FRLL and F4RH), fast scarlet VD, vulcan fast rubin B, brilliant scarlet G, lithol rubin GX, permanent red FSR, brilliant carmine 6B, pigment scarlet 3B, Bordeaux 5B, toluidine Maroon, permanent Bordeaux F2K, Helio Bordeaux BL, Bordeaux 10B, BON maroon light, BON maroon medium, eosin lake, rhodamine lake B, rhodamine lake Y, alizarin lake, thioindigo red B, thioindigo maroon, oil red, quinacridone red, pyrazolone red, polyazo red, chrome vermilion, benzidine orange, perinone orange, oil orange, cobalt blue, cerulean blue, alkali blue lake, peacock blue lake, Victoria blue lake, metal-free phthalocyanine blue, phthalocyanine blue, fast sky blue, indanthrene blue (RS and BC), indigo, ultramarine, iron blue, anthraquinone blue, fast violet B, methyl violet lake, cobalt purple, manganese violet, dioxane violet, anthraquinone violet, chrome green, zinc green, chromium oxide, viridian, emerald green, pigment green B, naphthol green B, green gold, acid green lake, malachite green lake, phthalocyanine green, anthraquinone green, titanium oxide, zinc flower, and lithopone.

An amount of the colorant is not particularly limited, and may be appropriately selected depending on the intended purpose. The amount of the colorant is preferably from 1 part by mass through 15 parts by mass, and more preferably from 3 parts by mass through 10 parts by mass, relative to 100 parts by mass of the toner.

The colorant may be also used as a master batch in which the colorant forms a composite with a resin. Examples of a resin used for production of the master batch or kneaded together with the master batch include, in addition to the amorphous polyester resin: polymers of styrene or substituted styrene, such as polystyrene, poly(p-chlorostyrene), and polyvinyl toluene; styrene-based copolymers, such as styrene-p-chlorostyrene copolymer, styrene-propylene copolymer, styrene-vinyl toluene copolymer, styrene-vinyl naphthalene copolymer, styrene-methyl acrylate copolymer, styrene-ethyl acrylate copolymer, styrene-butyl acrylate copolymer, styrene-octyl acrylate copolymer, styrene-methyl methacrylate copolymer, styrene-ethyl methacrylate copolymer, styrene-butyl methacrylate copolymer, styrene-methyl a-chloromethacrylate copolymer, styrene-acrylonitrile copolymer, styrene-methyl vinyl ketone copolymer, styrene-butadiene copolymer, styrene-isoprene copolymer, styrene-acrylonitrile-indene copolymer, styrene-maleic acid copolymer, and styrene-maleic acid ester copolymer; polymethyl methacrylate; polybutyl methacrylate; polyvinyl chloride; polyvinyl acetate; polyethylene; polypropylene; polyester; an epoxy resin; an epoxypolyol resin; polyurethane; polyamide; polyvinyl butyral; polyacrylic resin; rosin; modified rosin; a terpene resin; an aliphatic or alicyclic hydrocarbon resin; an aromatic petroleum resin; chlorinated paraffin; and paraffin wax. The above-listed examples may be used alone or in combination.

The master batch can be obtained by applying high shear force to a resin for a master batch and a colorant to mix and kneading the mixture. In order to enhance interaction between the colorant and the resin, an organic solvent can be used. Moreover, a so-called flashing method is preferably used, since a wet cake of the colorant can be directly used without being dried. The flashing method is a method in which an aqueous paste containing a colorant is mixed or kneaded with a resin and an organic solvent, and then the colorant is transferred to the resin to remove the moisture and the organic solvent. A high-shearing disperser (e.g., a three-roll mill) is preferably used for the mixing and kneading.

«Release Agent»

The release agent is not particularly limited and may be appropriately selected from release agents known in the art.

Examples of the release agent (e.g., wax) include natural wax, such as vegetable wax (e.g., carnauba wax, cotton wax, and Japanese wax), animal wax (e.g., bees wax and lanolin wax), mineral wax (e.g., ozocerite and ceresin), and petroleum wax (e.g., paraffin wax, microcrystalline wax, and petrolatum wax).

Moreover, the examples include, in addition to the above-listed natural wax, synthetic hydrocarbon wax (e.g., Fischer-Tropsch wax, polyethylene wax, and polypropylene wax), and synthetic wax (e.g., ester, ketone, and ether).

Furthermore, usable may be fatty acid amide-based compounds (e.g., 12-hydroxystearic acid amide, stearic acid amide, phthalimide anhydride, and chlorinated hydrocarbon), a low molecular-weight crystalline polyester resin, such as a homopolymer of polyacrylate (e.g., poly-n-stearylmethacrylate, and poly-n-laurylmethacrylate) or copolymer thereof (e.g., n-stearylacrylate-ethylmethacrylate copolymer), and a crystalline polymer having a long alkyl chain at a side chain thereof.

Among the above-listed examples, vegetable wax, and ester wax using a plant-derived material are preferable. Since the wax is plant derived, a resultant toner contributes to carbon neutrality even more.

A melting point of the release agent is not particularly limited, and may be appropriately selected depending on the intended purpose. The melting point of the release agent is preferably 60° C. or higher but 80° C. or lower. When the melting point is 60° C. or higher, the release agent does not melt at a low temperature and therefore desirable heat resistant storage stability is obtained. When the melting point is 80° C. or lower, the release agent is sufficiently melted and does not cause fixing offset when the resin is melted at the fixing temperature range, and therefore formation of image defects can be prevented.

An amount of the release agent is not particularly limited, and may be appropriately selected depending on the intended purpose. The amount of the release agent is preferably 2 parts by mass or greater but 10 parts by mass or less, and more preferably 3 parts by mass or greater but 8 parts by mass or less, relative to 100 parts by mass of the toner. When the amount thereof is 2 parts by mass or greater, desirable hot offset resistance during fixing and desirable low temperature fixability can be obtained. When the amount thereof is 10 parts by mass or less, desirable heat resistant storage stability can be obtained, and image fogging can be prevented. The amount of the release agent within the more preferable range is advantageous because image quality and fixing stability are improved.

«Other Components»

Examples of the above-mentioned other components included in the toner base particles include a charge controlling agent, a deformation agent, a flowability improving agent, a cleaning improving agent, and a magnetic material.

«<Charge Controlling Agent»>

The charge controlling agent is not particularly limited, and may be appropriately selected depending on the intended purpose. Examples of the charge controlling agent include a nigrosine-based dye, a triphenylmethane-based dye, a chrome-containing metal complex dye, a molybdic acid chelate pigment, a rhodamine-based dye, an alkoxy-based amine, a quaternary ammonium salt (including a fluorine-modified quaternary ammonium salt), alkylamide, phosphorus or a phosphorus compound, tungsten or a tungsten compound, a fluorosurfactant, a metal salt of salicylic acid, and a metal salt of a salicylic acid derivative.

Specific examples include nigrosine dye BONTRON 03, quaternary ammonium salt BONTRON P-51, metal-containing azo dye BONTRON S-34, oxynaphthoic acid-based metal complex E-82, salicylic acid-based metal complex E-84 and phenol condensate E-89 (all manufactured by ORIENT CHEMICAL INDUSTRIES CO., LTD); quaternary ammonium salt molybdenum complex TP-302 and TP-415 (all manufactured by Hodogaya Chemical Co., Ltd.); LRA-901, and boron complex LR-147 (manufactured by Japan Carlit Co., Ltd.); copper phthalocyanine; perylene; quinacridone; azo pigments; and other polymeric compounds having, as a functional group, a sulfonic acid group, carboxyl group, and quaternary ammonium salt.

An amount of the charge controlling agent is not particularly limited, and may be appropriately selected depending on the intended purpose. The amount of the charge controlling agent is preferably 0.1 parts by mass or greater but 10 parts by mass or less, and more preferably from 0.2 parts by mass through 5 parts by mass, relative to 100 parts by mass of the toner. When the amount of the charge controlling agent is 10 parts by mass or less, chargeability of a resultant toner is appropriate, an effect of a main charge controlling agent is excellent, an electrostatic suction force with a developing roller is appropriate, flowability of a resulting developer is excellent, and desired image density can be obtained. The charge controlling agent may be melt-kneaded with a master batch or resin, followed by dissolving and dispersing in an organic solvent. Alternatively, the charge controlling agent may be directly added when other materials are dissolved and dispersed, or may be deposited and fixed on surfaces of toner base particles, after producing the toner base particles.

«<Deformation Agent»>

In the present embodiment, the toner may include a deforming agent for the purpose of deforming particles of a color toner. The deformation agent is appropriately selected depending on the intended purpose, as long as the deformation agent can deform the toner particles. The deformation agent preferably includes a layered inorganic mineral, in which part of ions present between layers of the layered inorganic mineral are modified with organic ions.

The layered inorganic mineral, in which part of ions present between layers of the layered inorganic mineral are modified with organic ions, used as the deformation agent is not particularly limited, and may be appropriately selected depending on the intended purpose. For example, the layered inorganic mineral, in which part of ions present between the layers are modified with organic ions is preferably a layered inorganic mineral having a crystal structure of smectite, where part of ions is modified with organic cations. Moreover, metal anions can be introduced by substituting part of divalent metals of the layered inorganic mineral with trivalent metals. However, hydrophilicity increases when metal anions are introduced. Therefore, a layered inorganic compound at least part of which is modified with a metal anion is preferable.

An organic cation-modification agent of the layered inorganic mineral, in which at least part of ions of the layered inorganic mineral are modified with organic ions is not particularly limited as long as the modification agent can modify the layered inorganic mineral with organic ions. Examples thereof include alkyl quaternary ammonium salt, phosphonium salt, and imidazolium salt. Among the above-listed examples, alkyl quaternary ammonium salt is preferable. Examples of the alkyl quaternary ammonium salt include trimethylstearyl ammonium, dimethylstearylbenzyl ammonium, and oleylbis(2-hydroxyethyl)methylammonium.

An organic anion-modification agent of the layered inorganic mineral, in which at least part of ions of the layered inorganic mineral are modified with organic ions is not particularly limited as long as the modification agent can modify the layered inorganic mineral with organic ions. Examples thereof include sulfuric acid salt, sulfonic acid salt, carboxylic acid salt, or phosphoric acid salt including branched, non-branched, or cyclic alkyl (C1-C44), alkenyl (C1-C22), alkoxy (C8-C32), hydroxyalkyl (C2-C22), ethylene oxide, or propylene oxide. Among the above-listed examples, carboxylic acid having an ethylene oxide skeleton is desirable.

Since at least part of the layered inorganic mineral is modified with organic ions, the layered inorganic mineral has appropriate hydrophobicity, and an oil phase (described later) having the toner composition has non-Newtonian viscosity to make shapes of toner base particles irregular. An amount of the layered inorganic mineral part of which is modified with an organic ion in the toner materials is preferably from 0.05% by mass through 10% by mass, and more preferably from 0.05% by mass through 5% by mass.

Moreover, the layered inorganic mineral part of which is modified with an organic ion is appropriately selected. Examples thereof include montmorillonite, bentonite, hectorite, attapulgite, sepiolite, and a mixture thereof. Among the above-listed examples, organic-modified montmorillonite or bentonite is preferable because the viscosity is easily adjusted without affecting properties of a resultant toner, and efficacy thereof is obtained with a small amount thereof.

Examples of commercial products of the layered inorganic mineral part of which is modified with organic cations include: quaternium-18 bentonite, such as Bentone 3, Bentone 38, and Bentone 38V (all available from Elementis PLC), TIXOGEL VP (available from BYK), and CLAYTONE 34, CLAYTONE 40, and CLAYTONE XL (all available from BYK); stearalkonium bentonite, such as Bentone 27 (available from Elementis PLC), TIXOGEL LG (available from BYK), and CLAYTONE AF, and CLAYTONE APA (both available from BYK); and quaternium-18/benzalkonium bentonite, such as CLAYTONE HT and CLAYTONE PS (both available from BYK). Among the above-listed examples, CLAYTONE AF and CLAYTONE APA are preferable.

Moreover, the layered inorganic mineral part of which is modified with an organic anion is more preferably DHT-4A (available from Koyowa Chemical Industry Co., Ltd.) modified with the organic anion represented by General Formula (III) below. Examples of the organic anion represented by General Formula (III) include HITENOL 330T (available from DKS Co., Ltd.).

R₁(OR₂)ₙOSO₃ M General Formula (III)

In General Formula (III), R₁ is an alkyl group including 13 carbon atoms, R₂ is an alkylene group including from 2 through 6 carbon atoms, n is an integer of from 2 through 10, and M is a monovalent metal element.

Similarly to the amount of the layered inorganic mineral, an amount of the deformation agent in the toner is preferably 0.05% by mass or greater but 10% by mass or less, and more preferably 0.05% by mass or greater but 5% by mass or less.

«<Flowability Improving Agent»>

The flowability improving agent is not particularly limited and may be appropriately selected depending on the intended purpose, as long as the flowability improving agent is an agent used to perform a surface treatment to increase hydrophobicity to prevent degradation of flowability and charging properties even in a high humidity environment. Examples of the flowability improving agent include a silane coupling agent, a silylation agent, a silane-coupling agent containing a fluoroalkyl group, an organic titanate-based coupling agent, an aluminum-based coupling agent, silicone oil, and modified-silicone oil. The silica and the titanium oxide are particularly preferably subjected to a surface treatment with any of the above-listed flowability improving agents to be used as hydrophobic silica and hydrophobic titanium oxide.

«<Cleaning Improving Agent»>

The cleaning improving agent is not particularly limited and may be appropriately selected depending on the intended purpose, as long as the cleaning improving agent is an agent added to the toner in order to remove a developer remained on a photoconductor or a primary transfer member after transferring. Examples of the cleaning improving agent include: fatty acid (e.g., stearic acid) metal salts, such as zinc stearate, and calcium stearate; and polymer particles produced by soap-free emulsification polymerization, such as polymethyl methacrylate particles, and polystyrene particles. The polymer particles are preferably polymer particles having a relatively narrow particle size distribution. The polymer particles are preferably particles having the volume average particle diameter of from 0.01 micrometers through 1 micrometer.

«<Magnetic Material»>

The magnetic material is not particularly limited, and may be appropriately selected depending on the intended purpose. Examples of the magnetic material include iron powder, magnetite, and ferrite. Among the above-listed examples, white magnetic materials are preferable considering a color tone.

<External Additives>

As the external additives, in addition to oxide particles, inorganic particles or hydrophobicity-treated inorganic particles may be used in combination. The average primary particle diameter of the hydrophobicity-treated inorganic particles is preferably 1 nm or greater but 100 nm or less, and more preferably 5 nm or greater but 70 nm or less.

Moreover, the external additives preferably include at least one group of the hydrophobicity-treated inorganic particles having the average primary particle diameter of 20 nm or less, and at least one group of the hydrophobicity-treated inorganic particles having the average primary particle diameter of 30 nm or greater. Moreover, the BET specific surface area of the external additives is preferably 20 m²/g or greater but 500 m²/g or less.

The external additives are not particularly limited, and may be appropriately selected depending on the intended purpose. Examples of the external additives include silica particles, hydrophobic silica, fatty acid metal salts (e.g., zinc stearate, and aluminium stearate), metal oxide (e.g., titania, alumina, tin oxide, and antimony oxide), and fluo-ropolymers.

Examples of preferable additives include hydrophobic silica, titania, titanium oxide, and alumina particles.

Examples of the silica particles include R972, R974, RX200, RY200, R202, R805, and R812 (all available from NIPPON AEROSIL CO., LTD.).

Examples of the titania particles include: P-25 (available from NIPPON AEROSIL CO., LTD.); STT-30, and STT-65C-S(both available from Titan Kogyo Ltd.); TAF-140 (available from Fuji Titanium Industry, Co., Ltd.); and MT-150W, MT-500B, MT-600B, and MT-150A (all available from Tyca Corp.).

Examples of the hydrophobicity-treated titanium oxide particles include: T-805 (available from NIPPON AEROSIL CO., LTD.); STT-30A, and STT-65S-S(both available from Titan Kogyo Ltd.); TAF-500T, and TAF-1500T (both available from Fuji Titanium Industry, Co., Ltd.); MT-100S and MT-100T (both available from Tyca Corp.); and IT-S(available from Ishihara Sangyo Kaisha Ltd.).

Hydrophobicity-treated oxide particles, hydrophobicity-treated silica particles, hydrophobicity-treated titania particles, and hydrophobicity-treated alumina particles can be obtained, for example, by treating hydrophilic particles with a silane coupling agent, such as methyltrimethoxysilane, methyltriethoxysilane, and octyltrimethoxysilane. Moreover, silicone oil-treated oxide particles where the inorganic particles are optionally treated by adding silicone oil, can be suitably used.

Examples of the silicone oil include dimethyl silicone oil, methylphenyl silicone oil, chlorophenyl silicone oil, methylhydrogen silicone oil, alkyl-modified silicone oil, fluorine-modified silicone oil, polyether-modified silicone oil, alcohol-modified silicone oil, amino-modified silicone oil, epoxy-modified silicone oil, epoxy/polyether-modified silicone oil, phenol-modified silicone oil, carboxyl-modified silicone oil, mercapto-modified silicone oil, methacryl-modified silicone oil, and a-methylstyrene-modified silicone oil.

Examples of the inorganic particles include silica, alumina, titanium oxide, barium titanate, magnesium titanate, calcium titanate, strontium titanate, iron oxide, copper oxide, zinc oxide, tin oxide, quartz sand, clay, mica, wollastonite, diatomite, chromium oxide, cerium oxide, red iron oxide, antimony trioxide, magnesium oxide, zirconium oxide, barium sulfate, barium carbonate, calcium carbonate, silicon carbide, and silicon nitride. Among the above-listed examples, silica and titanium dioxide are preferable.

An amount of the external additives is not particularly limited, and may be appropriately selected depending on the intended purpose. The amount of the external additive is preferably from 0.1 parts by mass through 5 parts by mass, and more preferably from 0.3 parts by mass through 3 parts by mass, relative to 100 parts by mass of the toner.

The average primary particle diameter of the inorganic particles is not particularly limited, and may be appropriately selected depending on the intended purpose. The average primary particle diameter of the inorganic particles is preferably 100 nm or less, and more preferably 3 nm or greater but 70 nm or less. When the average primary particle diameter of the inorganic particles is 3 nm or greater, the following problem can be prevented. That is, the inorganic particles are embedded in a toner base particles, and a function of the inorganic particles may not be effectively exhibited. When the average primary particle diameter of the inorganic particles is 100 nm or less, a surface of a photoconductor may not be unevenly scratched.

<Glass Transition Temperature>

«Tg1st (Toner)»

A glass transition temperature [Tg1st (toner)] of the toner measured from 1st heating of differential scanning calorimetry (DSC) is not particularly limited, and may be appropriately selected depending on the intended purpose. The glass transition temperature [Tg1st (toner)] is preferably 20° C. or higher but 50° C. or lower, more preferably 35° C. or higher but 45° C. or lower considering low temperature fixability. When Tg of a conventional toner is about 50° C. or lower, aggregation of toner

particles tends to occur due to temperature fluctuations during transportation and storage environments of a toner, considering use of the toner in summer or in the tropical regions. As a result, the toner may be solidified in a toner bottle, or the adhesion of the toner may be caused inside a developing device. Moreover, toner supply failures may be cause due to toner clogging inside the toner bottle, or image defects may be caused due to the toner adhesion inside the developing device.

Heat resistant storage stability of the toner can be secured when the amorphous polyester resin A, which is a low Tg component in the toner, is a non-linear molecule even though Tg of the toner is lower than Tg of a conventional toner. Particularly when the amorphous polyester resin A has a urethane bond or urea bond having high aggregation force, an effect of securing heat resistant storage stability becomes more significant.

When [Tg1st (toner)] is 20° C. or higher, degradation of heat resistant storage stability, blocking inside a developing device, and filming to a photoconductor can be prevented. When [Tg1st (toner)] is 50° C. or lower, degradation of low temperature fixability of the toner can be prevented.

«Tg2nd (Toner)»

A glass transition temperature [Tg2nd (toner)] of the toner measured from second heating of differential scanning calorimetry (DSC) is not particularly limited, and may be appropriately selected depending on the intended purpose. The glass transition temperature [Tg2nd (toner)] is preferably 0° C. or higher but 30° C. or lower, and more preferably 0° C. or higher but 15° C. or lower. When the glass transition temperature [Tg2nd (toner)] is 0° C. or higher, degradation of blocking resistance of a fixed image (a print) can be prevented. When the glass transition temperature [Tg2nd (toner)] is 30° C. or lower, degradation of low temperature fixability or reduction in glossiness can be prevented.

For example, the glass transition temperature [Tg2nd (toner)] can be adjusted by adjusting Tg of the crystalline polyester resin and an amount of the crystalline polyester resin added.

«[Tg1st (Toner)—Tg2nd (Toner)]»

A difference [Tg1st (toner)—Tg2nd (toner)] between the glass transition temperature [Tg1st (toner)] of the toner measured from the first heating of DSC and the glass transition temperature [Tg2nd (toner)] of the toner measured from the second heating of DSC is not particularly limited, and may be appropriately selected depending on the intended purpose. The difference [Tg 1st (toner)—Tg2nd (toner)] is preferably 10° C. or greater. The upper limit of the difference [Tg 1st (toner)—Tg2nd (toner)] is not particularly limited, and may be appropriately selected depending on the intended purpose. The difference [Tg1st (toner)—Tg2nd (toner)] is preferably 50° C. or less.

When the difference [Tg 1st (toner)—Tg2nd (toner)] is 10° C. or greater, it is advantageous because excellent low temperature fixability is obtained. The deference [Tg1st (toner)—Tg2nd (toner)] being 10° C. or greater means that the crystalline polyester resin C, the amorphous polyester resin A, and the amorphous polyester resin B present in a non-compatible state before heating (before first heating) becomes a compatible state after heating (after first heating). The compatible state after heating is not necessarily a completely compatible state.

«Tg2nd (THF Insoluble Component)»

A glass transition temperature [Tg2nd (THF insoluble component)] of the tetrahydrofuran(THF) insoluble component of the toner measured from second heating of differential scanning calorimetry (DSC) is not particularly limited, and may be appropriately selected depending on the intended purpose. For example, the glass transition temperature [Tg2nd (THF insoluble component)] is preferably −40° C. or higher but 30° C. or lower, and more preferably 0° C. or higher but 20° C. or lower. When the glass transition temperature [Tg2nd (THF insoluble component)] is −40° C. or higher, degradation of blocking resistance of a fixed image (a print) can be prevented. When the glass transition temperature [Tg2nd (THF insoluble component)] is 30° C. or lower, degradation of low temperature fixability or reduction in glossiness can be prevented.

For example, the [Tg2nd (THF insoluble component)] can be adjusted by adjusting the number of carbon atoms in diol and dicarboxylic acid of the amorphous polyester resin A.

<Storage Elastic Modulus>

«G′(100) (THF insoluble component) and [G′(40) (THF insoluble component)/G′(100) (THF insoluble component)]»

The storage elastic modulus [G′(100) (THF insoluble component)] of the tetrahydrofuran (THF)-insoluble component of the toner at 100° C. is not particularly limited, and may be appropriately selected depending on the intended purpose. The storage elastic modulus [G′(100) (THF insoluble component)] of the tetrahydrofuran (THF)-insoluble component is preferably from 1.0×10⁵ Pa through 1.0×10⁷ Pa, and more preferably from 5.0×10⁵ Pa through 5.0×10⁶ Pa. When the storage elastic modulus [G′(100) (THF insoluble component)] is within the above-mentioned more preferable range, excellent low temperature fixability can be obtained.

A ratio [[G′(40) (THF insoluble component)]/[G′(100) (THF insoluble component)]] of the storage elastic modulus [G′(40) (THF insoluble component)] of the THF insoluble component of the toner at 40° C. to the storage elastic modulus [G′(100) (THF insoluble component)] thereof at 100° C. is not particularly limited, and may be appropriately selected depending on the intended purpose. The ratio [[G′(40) (THF insoluble component)]/[G′(100) (THF insoluble component)]] is preferably 3.5×10 or less. When the ratio [[G′(40) (THF insoluble component)]/[G′(100) (THF insoluble component)]] is 3.5×10 or less, degradation of low temperature fixability can be prevented.

Since the [G′(100) (THF insoluble component)] of the toner is from 1.0×10⁵ Pa through 1.0×10⁷ Pa, and the ratio [[G′(40) (THF insoluble component)KG′(100) (THF insoluble component)]] is 3.5×10 or less, compatibility between the crystalline polyester resin and the amorphous polyester resin that is a high Tg component is increased to reduce a 1/2 distillation temperature, and therefore image glossiness is improved.

For example, the values of the [G′(100) (THF insoluble component)] and the [G′(40) (THF insoluble component)] can be adjusted by a resin composition (bifunctional or higher polyol, and bifunctional or higher acid component).

For example, the values thereof can be specifically adjusted in the following manner. In order to increase G′, a distance of an ester bond in the resin can be shortened, or a resin composition having an aromatic ring is used. In order to reduce G′, a linear polyester resin is used, and polyol including an alkyl group in a side chain thereof is used as a constitutional component of the polyester resin.

«THF Insoluble Component»

The THF insoluble component of the toner can be obtained in the following manner. One part of the toner is added to 100 parts of tetrahydrofuran (THF), and the resultant mixture is subjected to reflux for 6 hours. Thereafter, the insoluble component is precipitated by a centrifugal separator to separate the insoluble component from the supernatant liquid.

The insoluble component is dried at 40° C. for 20 hours to obtain a THF insoluble component.

«Measuring Method of Storage Elastic Modulus G′»

The storage elastic modulus (G′) under various conditions can be measured, for example, by means of a dynamic viscoelasticity measuring device (ARES, available from TA Instruments Japan Inc.). The frequency during the measurement is 1 Hz.

Specifically, a measuring sample is molded to form a pellet having a diameter of 8 mm and a thickness of from 1 mm through 2 mm, and the sample is fixed on a parallel plate having a diameter of 8 mm, followed by stabilizing at 40° C. The sample is then heated to 200° C. at the heating rate of 2.0° C./min, at a frequency of 1 Hz (6.28 rad/s) and a strain amount of 0.1% (in the strain amount controlling mode), to thereby measure a storage elastic modulus.

In the present specification, the storage elastic modulus at 40° C. may be represented as G′(40° C.), and the storage elastic modulus at 100° C. may be represented as G′ (100° C.).

<Melting Point>

A melting point of the toner is not particularly limited, and may be appropriately selected depending on the intended purpose. The melting point of the toner is preferably 60° C. or higher but 80° C. or lower.

<Volume Average Particle Diameter>

The volume average particle diameter of the toner is not particularly limited, and may be appropriately selected depending on the intended purpose. The volume average particle diameter of the toner is preferably 3 micrometers or greater but 7 micrometers or less. A ratio of the volume average particle diameter to the number average particle diameter is preferably 1.2 or less. Moreover, the toner preferably includes 1% by number or greater but 10% by number or less of a component having the volume average particle diameter of 2 micrometers or less.

<Calculation Methods and Analysis Method of Various Characteristics of Toner and Toner Constitutional Components>

The glass transition temperature Tg, acid value, hydroxyl value, molecular weight, and melting point of the amorphous polyester resin A, the amorphous polyester resin B, the crystalline polyester resin C, and the release agent may be measured by performing each measurement on each material. Alternatively, gel permeation chromatography (GPC) etc. may be performed on the toner to separate into components, and each of the separated components is subjected to the below-described analysis to calculate Tg, a molecular weight, a melting point and a mass ratio of the constitutional components.

For example, separation of components by GPC can be performed by the following method.

In GPC using tetrahydrofuran (THF) as a mobile phase, the eluate is separated by a fraction collector etc., and the fractions are combined to correspond to a desired molecular weight region among the entire area of the elution curve.

After concentrating and drying the combined eluate by an evaporator etc., the solids are dissolved in a deuterated solvent, such as deuterochloroform and deuterated THF, 1 H-NMR is performed thereon, and a constitutional monomer ratio of the resin in the eluted component is calculated from an integrated ratio of each element.

As another method, moreover, after concentrating the eluate, hydrolysis is performed using sodium hydroxide etc., the decomposed product is subjected to a qualitative and quantitative analysis through high performance liquid chromatography (HPLC) to calculate a constitutional monomer ratio.

When the production method of the toner is a method where toner base particles are formed while the amorphous polyester resin A is generated through an elongation reaction and/or cross-linking reaction between the non-linear reactive precursor and the curing agent, the amorphous polyester resin A is separated from the produced toner by GPC etc., and then Tg of the amorphous polyester resin A may be determined. Alternatively, an elongation reaction and/or cross-linking reaction between the non-linear reactive precursor and the curing agent is performed separately to synthesize an amorphous polyester resin A, and Tg may be measured from the synthesized amorphous polyester resin A.

«Separation Method of Toner Constitutional Components»

One example of a separation method of each component when the toner is analyzed will be described in detail.

First, 1 g of the toner is added to 100 mL of THF. The resultant is stirred for 30 minutes at 25° C. to thereby obtain a solution in which a THF soluble component is dissolved. Subsequently, the solution is filtered with a membrane filter having an opening size of 0.2 micrometers, to thereby obtain a THF soluble component of the toner.

Next, the THF soluble component is dissolved in THF, and the resultant is injected as a sample for GPC into GPC used for measuring a molecular weight of each of the above-mentioned resins.

Meanwhile, a fraction collector is disposed at the eluate output of GPC, and the eluate is separated per the predetermined count to thereby obtain an eluate per 5% of an image area from the elution onset of the elution curve (rise of the curve).

Subsequently, 30 mg of each elution fraction as a sample is dissolved in 1 mL of deuterochloroform, and 0.05% by volume of tetramethyl silane (TMS) is added as a standard material.

A glass tube for NMR having a diameter of 5 mm is charged with the resultant solution, and a measurement is performed by means of a nuclear magnetic resonance spectrometer (JNM-AL400, available from JEOL Ltd.) at a temperature of from 23° C. through 25° C., with integrations of 128 times, to thereby obtain a spectrum.

The monomer composition and constitutional ratio of the amorphous polyester resin A, the amorphous polyester resin B, and the crystalline polyester resin C included in the toner are determined from a peak integration ratio of the obtained spectrum.

For example, the peaks are assigned as follows, and a component ratio of each constitutional monomer is determined from the integration ratio.

For example, the assignment of peaks is as follows.

Near 8.25 ppm: derived from a benzene ring of trimellitic acid (one hydrogen atom)

From near 8.07 ppm through near 8.10 ppm: derived from a benzene ring of terephthalic acid (four hydrogen atoms)

From near 7.1 ppm through near 7.25 ppm: derived from a benzene ring of bisphenol A (four hydrogen atoms)

Near 6.8 ppm: derived from a benzene ring of bisphenol A (four hydrogen atoms) and derived from a double bond of fumaric acid (two hydrogen atoms)

From near 5.2 ppm through near 5.4 ppm: derived from methine of a bisphenol A propylene oxide adduct (one hydrogen)

From near 3.7 ppm through near 4.7 ppm: derived from methine of a bisphenol A propylene oxide adduct (two hydrogen atoms) and derived from methane of a bisphenol A ethylene oxide adduct (four hydrogen atoms)

Near 1.6 ppm: derived from a methyl group of bisphenol A (six hydrogen atoms) From the results above, for example, the extract collected in the fraction in which the amorphous polyester resin A occupies 90% or greater may be determined as the amorphous polyester resin A. Similarly, the extract collected in the fraction in which the amorphous polyester resin B occupies 90% or greater may be determined as the amorphous polyester resin B, and the extract collected in the fraction in which the crystalline polyester resin C occupies 90% or greater may be determined as the crystalline polyester resin C.

«Measurement Method of Melting Point and Glass Transition Temperature (Tg)»

In the present disclosure, a melting point and a glass transition temperature (Tg) can be measured, for example, by means of a DSC system (differential scanning calorimeter) (Q-200, available from TA Instruments Japan Inc.).

Specifically, a melting point and glass transition temperature of a sample can be measured in the following manner.

First, a sample container formed of aluminium is charged with about 5.0 mg of a sample, the sample container is placed on a holder unit, and the holder unit is set in an electric furnace. Next, the sample is heated from −80° C. to 150° C. at the heating rate of 1.0° C./min in a nitrogen atmosphere (first heating). Then, the sample is cooled from 150° C. to −80° C. at the cooling rate of 10° C./min, followed by again heating to 150° C. at the heating rate of 10° C./min (second heating). DSC curves for the first heating and the second heating are each measured by means of a differential scanning calorimeter (Q-200, available from TA Instruments Japan Inc.).

The DSC curve for the first heating is selected from the obtained DSC curves using an analysis program installed in the Q-200 system, and a glass transition temperature of the sample at the first heating is determined. Similarly, the DSC curve at the second heating is selected, and a glass transition temperature of the sample at the second heating is determined.

The DSC curve for the first heating is selected from the obtained DSC curves using an analysis program installed in the Q-200 system, and the endothermic peak top temperature of the sample at the first heating is determined as a melting point. Similarly, the DSC curve at the second heating is selected, and an endothermic peak top temperature of the sample at the second heating is determined as a melting point.

In the present specification, when the toner is used as a sample, the glass transition temperature at the first heating is determined as the glass transition temperature Tg₁ₛₜ, and the glass transition temperature at the second heating is determined as the glass transition temperature Tg_{2nd}

In the present specification, moreover, as a melting point and glass transition temperature Tg of the amorphous polyester resin A, the amorphous polyester resin B, the crystalline polyester resin C, and other constitutional components, such as the release agent, the endothermic peak top temperature and the glass transition temperature Tg at the second heating are determined as a melting point and glass transition temperature Tg of each component, unless otherwise stated.

«Measurement Method of Particle Size Distribution»

The volume average particle diameter (D4) and number average particle diameter (Dn) of the toner, and the ratio (D4/Dn) can be measured, for example, by means of Coulter Counter TA-II or Coulter Multisizer II (both available from Beckman Coulter Inc.). In the present disclosure, Coulter Multisizer II is used. The measurement method will be described hereinafter.

First, 0.1 mL through 5 mL of a surfactant (preferably polyoxyethylene alkyl ether (nonionic surfactant)) serving as a dispersant is added to from 100 mL through 150 mL of an electrolytic aqueous solution. The electrolytic aqueous solution is prepared as an about 1% NaCl aqueous solution using grade-1 sodium chloride. As the electrolytic aqueous solution, for example, ISOTON-II (available from Beckman Coulter, Inc.) may be used. Next, from 2 mg through 20 mg of a measurement sample is added to the resultant solution. The electrolytic solution to which the sample is suspended is subjected to a dispersion treatment for about 1 minute through about 3 minutes by means of an ultrasonic wave disperser. The resultant dispersion is provided to the measurement device with an aperture of 100 micrometers to measure a volume and the number of toner particles or toner to thereby calculate a volume distribution and a number distribution. The volume average particle diameter (D4) and number average particle diameter (Dn) of the toner can be determined from the obtained distributions.

As channels, the following 13 channels are used: 2.00 micrometers or greater but less than 2.52 micrometers; 2.52 micrometers or greater but less than 3.17 micrometers; 3.17 micrometers or greater but less than 4.00 micrometers; 4.00 micrometers or greater but less than 5.04 micrometers; 5.04 micrometers or greater but less than 6.35 micrometers; 6.35 micrometers or greater but less than 8.00 micrometers; 8.00 micrometers or greater but less than 10.08 micrometers; 10.08 micrometers or greater but less than 12.70 micrometers; 12.70 micrometers or greater but less than 16.00 micrometers; 16.00 micrometers or greater but less than 20.20 micrometers; 20.20 micrometers or greater but less than 25.40 micrometers; 25.40 micrometers or greater but less than 32.00 micrometers; and 32.00 micrometers or greater but less than 40.30 micrometers. The target particles for the measurement are particles having the diameters of 2.00 micrometers or greater but less than 40.30 micrometers.

«Average Particle Diameter and Average Circularity»

In the present embodiment, for example, a flow particle imaging instrument FPIA-3000 (available from SYSMEX CORPORATION) is used for measuring the average particle diameter and the average circularity.

As a specific measuring method, from 0.1 mL through 0.5 mL of a surfactant, preferably alkylbenzene sulfonic acid salt, as a dispersant is added to from 100 mL through 150 mL of water in a vessel, from which solid impurities have been removed. Then, from about 0.1 g through about 0.5 g of the measuring sample is added. The suspension liquid, in which the sample is dispersed, is dispersed by an ultrasonic wave disperser for from about 1 minute through about 3 minutes. The resultant is subjected to measurements of the average particle diameter, the average circularity, and the standard deviation (SD) of circularity by the above-mentioned device with adjusting the concentration of the dispersion liquid to the range of from 3,000 particles per microliter through 10,000 particles per microliter.

The particle diameter is determined as a circle equivalent diameter, and the average particle diameter is determined as the average circle equivalent diameter (number based). The analysis conditions of the flow particle image analyzer are as follows.

Particle diameter restriction: 0.5 micrometerscircle equivalent diameter (number based)≤200.0 micrometers

Particle shape restriction: 0.93<circularity≤1.00

In the present embodiment, moreover, the average circularity is defined as follows.

(Average circularity)=(length of circumference of circle having equivalent area to projected image area)/(length of boundary of projected image) «Measurement of Molecular Weight»

For example, a molecular weight of each constitutional component of the toner can be measured by the following method.
Gel permeation chromatography (GPC) measuring device: GPC-8220GPC (available from Tosoh Corporation)
Column: TSKgel SuperHZM-H 15 cm triple column (available from Tosoh Corporation)
Temperature: 40° C.
Solvent: THF
Flow rate: 0.35 mL/min
Sample: 100 microliters of a 0.15% by mass sample injected

Pretreatment of sample: after dissolving the toner in tetrahydrofuran (THF, including a stabilizer, available from Wako Chemical Co., Ltd.) at a concentration of 0.15% by mass, a resultant is filtered with a filter having an opening size of 0.2 micrometers. The obtained filtrate is used as a sample. The THF sample solution (100 microliters) is injected to perform a measurement.

For the molecular weight measurement of the sample, the molecular weight distribution of the sample is calculated from the relationship between the logarithm value and the count number of the calibration curve produced from several monodispersible polystyrene standard samples. As the polystyrene standard samples for preparing the calibration curve, Showdex STANDARD Std. Nos. S-7300, S-210, S-390, S-875, 5-1980, S-10.9, S-629, S-3.0, and S-0.580 available from SHOWA DENKO K. K. are used. A refractive index (RI) detector is used as a detector.

«Major Axis and Aspect Ratio of Crystalline Polyester Resin»

The major axis and aspect ratio of the crystalline polyester resin of the toner can be measured, for example, by the following methods.

The toner is embedded in a visible light-curable embedding resin (D-800, available from Nissin EM Co., Ltd.). The resin is then sliced into a 60 nm-thick piece by means of an ultrasonic ultramicrotome (EM5, available from Leica Microsystems). The cut piece is dyed with Ru using a vacuum electron staining apparatus (available from Filgen, Inc.). Thereafter, the dyed cut piece is observed under a transmissive electron microscope (H7500, available from Hitachi, Ltd.) at acceleration voltage of 120 kV. For the observation of the toner, 50 particles having the particle diameters that are within ±2.0 micrometers from the weight average particle diameter were selected and the images thereof are captured. In case of the configuration of the present disclosure, as a result of the RuO₄ dying, the color contrast of the polyester resin in the toner appears dark. In the case where wax is used, the wax appears even darker. The average major axis and average aspect ratio of the domains formed of the polyester resin C can be determined from the observed image, but the average aspect ratio can be calculated using image processing software.

As the image processing software, Image-Pro Plus 5.1J (available from MediaCybernetics) can be used. The cross-sectional image of the toner particles captured by the above-described method is used. In order to extract the toner particles to be analyzed, first, the toner particle sections are selected to separate the toner particles from the background. “Measurement”−“Count/Size” of Image-Pro Plus 5.1J is selected. From the window of “Count/Size,” “Measurement”−“Measuring Item” is selected. From the measuring items, “Diameter (Minimum)” and “Diameter (Maximum)” are selected. For “Luminance Range Selection,” the luminance range needs to be adjusted to select only the polyester resin A. It is necessary to adjust the luminance range for each measurement depending on the conditions of RuO₄ dying, but the polyester resin A can be easily determined from the above-described color contrast (shading). “Count” is selected to display the measurement results. Thereafter, an aspect ratio (major axis/minor axis) can be determined using the obtained “Diameter (Minimum)” as the minor axis, and “Diameter (Maximum)” as the major axis. From the data of the aspect ratio of one toner particle obtained in the above-described manner, an average value of 10 values selected in the order from the largest diameter (maximum) is determined. The determination of the average value is repeated on 10 toner particles to determine an average value of the aspect ratio.

The major axis of the domain of the crystalline polyester resin is preferably 2.0 micrometers or less, and more preferably 1.0 micrometer or less. When the major axis thereof is large, the crystalline polyester resin tends to expose to a surface of the toner base particle to increase adhesion of the toner, leading to poor cleaning performance. The aspect ratio is preferably 4.0 or greater, and more preferably 10.0 or greater. When the aspect ratio is small, the contact area of the crystalline polyester resin with the amorphous polyester resin becomes small to impair compatibility between the amorphous polyester resin and the crystalline polyester resin, and therefore desirable low temperature fixability may not be obtained.

<Measurement of Particle Diameter of Wax in Wax Dispersion Liquid>

The particle diameter of the wax particles in the wax dispersion liquid of the present disclosure can be measured, for example, by means of Nanotrac particle size distribution analyzer UPA-EX150 (available from MicrotracBEL Corp., the dynamic light scattering/laser Doppler method). As a specific measuring method, a dispersion liquid, in which wax particles are dispersed, is adjusted to have the concentration within the measuring concentration range, and then is subjected to a measurement. At the time of measuring, a background is measured in advance by measuring only a dispersion solvent of the dispersion liquid. According to the measuring method as described above, the particle diameters of the wax particles for use in the present disclosure can be measured in the order of several tens nanometers to several micrometers, which is the volume average particle diameter range.

In the present disclosure, the particle diameter of the wax is the volume average particle diameter.

In the present disclosure, the particle diameter of the wax in the wax dispersion liquid is preferably 50 nm or greater but 600 nm or less, and more preferably 50 nm or greater but 300 nm or less.

<Measurement of Particle Diameter of Crystalline Polyester Resin in Crystalline Polyester Resin Dispersion Liquid>

The particle diameter of the crystalline polyester resin particles in the crystalline polyester resin dispersion liquid of the present disclosure can be measured, for example, by means of Nanotrac particle size distribution analyzer UPA-EX150 (available from MicrotracBEL Corp., the dynamic light scattering/laser Doppler method). As a specific measuring method, a dispersion liquid, in which crystalline polyester resin particles are dispersed, is adjusted to have the concentration within the measuring concentration range, and then is subjected to a measurement. At the time of measuring, a background is measured in advance by measuring only a dispersion solvent of the dispersion liquid. According to the measuring method as described above, the particle diameters of the resin particles for use in the present disclosure can be measured in the order of several tens nanometers to several micrometers, which is the volume average particle diameter range.

In the present disclosure, the particle diameter of the crystalline polyester resin is the volume average particle diameter of the particles of the crystalline polyester resin. In the present disclosure, the dispersed particle diameter of the crystalline polyester resin in the crystalline polyester resin dispersion liquid is preferably 20 nm or greater but 500 nm or less, and more preferably 50 nm or greater but 300 nm or less.

<Method for Producing Toner>

The method for producing a toner is not particularly limited, and may be appropriately selected depending on the intended purpose. The method preferably includes a mixing step including mixing the toner base particles and the external additives.

The toner base particles are formed by dispersing, in an aqueous medium, an oil phase preferably including the amorphous polyester resin A, the amorphous polyester resin B, and the crystalline polyester resin C, and optionally including the release agent and the colorant.

Moreover, the toner base particles are preferably formed by dispersing, in an aqueous medium, an oil phase preferably including the non-linear reactive precursor, the amorphous polyester resin B, and the crystalline polyester resin C, and optionally including the curing agent, the release agent, and the colorant.

As an example of the production method of the toner base particles, there is an emulsification aggregation method known in the art. As an example of the production method of the toner base particles, a method where an amorphous polyester resin A is elongated through an elongation reaction and/or cross-linking reaction between the prepolymer and the curing agent to form toner base particles will be described hereinafter. In the above-mentioned method, preparation of an aqueous medium, preparation of an oil phase including toner materials, phase inversion emulsification of the toner materials, and removal of an organic solvent are performed to obtain a particle dispersion liquid. The particles in the particle dispersion liquid are aggregated and fused together to obtain toner base particles. Thereafter, the obtained toner base particles and the external additive are mixed to obtain the toner.

«Preparation of Aqueous Medium (Aqueous Phase)»

The aqueous medium is not particularly limited, and may be appropriately selected depending on the intended purpose. Examples of the aqueous medium include water, a solvent miscible with water, and a mixture thereof. The above-listed examples may be used alone or in combination. Among the above-listed examples, water is preferable.

The solvent miscible with water is not particularly limited, and may be appropriately selected depending on the intended purpose. Examples thereof include alcohol, dimethylformamide, tetrahydrofuran, cellosolves, and lower ketones.

The alcohol is not particularly limited, and may be appropriately selected depending on the intended purpose. Examples of the alcohol include methanol, isopropanol, and ethylene glycol.

The lower ketones are not particularly limited, and may be appropriately selected depending on the intended purpose. Examples of the lower ketones include acetone, and methyl ethyl ketone.

«Preparation of Oil Phase»

For example, the oil phase including the toner materials may be prepared by dissolving or dispersing the toner materials in an organic solvent. The toner materials include the non-linear reactive precursor, the amorphous polyester resin B, and the crystalline polyester resin C, and may further include the curing agent, the release agent, and the colorant according to the necessity. Moreover, the oil phase may include a deformation agent.

The organic solvent is not particularly limited, and may be appropriately selected depending on the intended purpose. The organic solvent is preferably an organic solvent having a boiling point of lower than 150° C. considering easiness of removal thereof.

The organic solvent having a boiling point of lower than 150° C. is not particularly limited, and may be appropriately selected depending on the intended purpose. Examples thereof include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. The above-listed examples may be used alone or in combination.

Among the above-listed examples, ethyl acetate, toluene, xylene, benzene, methylene chloride, 1,2-dichloroethane, chloroform, and carbon tetrachloride are preferable, and ethyl acetate is more preferable.

«Phase Inversion Emulsification»

Phase inversion emulsification of the toner materials can be performed by dispersing the oil phase including the toner materials in the aqueous medium. When the toner materials are emulsified or dispersed, the curing agent and the non-linear reactive precursor are reacted through an elongation reaction and/or cross-linking reaction to generate the amorphous polyester resin A.

The amorphous polyester resin A can be generated, for example, by any of the following methods (1) to (3).
(1) A method where an oil phase including the non-linear reactive precursor and the curing agent is emulsified or dispersed in an aqueous medium to allow the curing agent and the non-linear reactive precursor to react through an elongation reaction and/or cross-linking reaction in the aqueous medium to generate the amorphous polyester resin A.
(2) A method where an oil phase including the non-linear reactive precursor is emulsified or dispersed in an aqueous medium, to which the curing agent has been added in advance, to react the curing agent and the non-linear reactive precursor through an elongation reaction and/or cross-linking reaction in the aqueous medium to generate the amorphous polyester resin A.
(3) A method where an oil phase including the non-linear reactive precursor is emulsified or dispersed in an aqueous medium, followed by adding the curing agent to the aqueous medium to allow the curing agent and the non-linear reactive precursor to react from the interfaces particles through an elongation reaction and/or cross-linking reaction in the aqueous medium to generate the amorphous polyester resin A.

When the curing agent and the non-linear reactive precursor are reacted through an elongation reaction and/or cross-linking reaction from the interfaces of the particles, the amorphous polyester resin A is predominantly formed on surfaces of toner particles generated to provide a concentration gradient of the amorphous polyester resin A within the toner particle.

The reaction conditions (e.g., a reaction time and a reaction temperature) for generating the amorphous polyester resin A are not particularly limited, and may be appropriately selected according to a combination of the curing agent and the non-linear reactive precursor.

The reaction time is not particularly limited, and may be appropriately selected depending on the intended purpose. The reaction time is preferably 10 minutes or longer but 40 hours or shorter, and more preferably 2 hours or longer but 24 hours or shorter.

The reaction temperature is not particularly limited, and may be appropriately selected depending on the intended purpose. The reaction temperature is preferably 0° C. or higher but 150° C. or lower, and more preferably 40° C. or higher but 98° C. or lower.

A method for performing phase inversion emulsification of the dispersion liquid including the non-linear reactive precursor in the aqueous medium is not particularly limited, and may be appropriately selected depending on the intended purpose. Examples thereof include a method where the oil phase is neutralized with base, followed by adding the aqueous phase to phase inverting the water in oil dispersion liquid to an oil in water dispersion liquid, or phase inversion is performed to obtain the particle dispersion liquid.

The base used for neutralizing the oil phase is not particularly limited, and may be appropriately selected depending on the intended purpose. Examples of the base include sodium hydroxide, potassium hydroxide, and ammonia water.

An amount of the aqueous medium used when the oil phase including the toner materials is phase inversion emulsified is not particularly limited, and may be appropriately selected depending on the intended purpose. The amount of the aqueous medium is 50 parts by mass or greater but 2,000 parts by mass or less, and more preferably 100 parts by mass or greater but 1,000 parts by mass or less, relative to 100 parts by mass of the toner materials.

When the amount of the aqueous medium is 50 parts by mass or greater, an appropriate dispersed state of the toner materials is maintained to obtain the predetermined particle diameter of the toner base particles. When the amount of the aqueous medium is 2,000 parts by mass or less, the production cost is maintained appropriately without increasing too high.

When the oil phase including the toner materials is phase inversion emulsified, a dispersant is preferably used in order to stabilize dispersed elements, such as oil droplets, to obtain desired shapes, as well as making the particle size distribution sharp. The dispersant is not particularly limited, and may be appropriately selected depending on the intended purpose. Examples of the dispersant include a surfactant, a poorly water-soluble inorganic compound dispersant, and a polymeric protective colloid. The above-listed examples may be used alone or in combination. Among the above-listed examples, a surfactant is preferable.

The surfactant is not particularly limited, and may be appropriately selected depending on the intended purpose. For example, an anionic surfactant, a cationic surfactant, a nonionic surfactant, or an amphoteric surfactant may be used as the surfactant.

The anionic surfactant is not particularly limited, and may be appropriately selected depending on the intended purpose. Examples thereof include alkyl benzene sulfonic acid salt, α-olefin sulfonic acid salt, and phosphoric acid ester. Among the above-listed examples, a surfactant including a fluoroalkyl group is preferable.

A catalyst may be used for an elongation reaction and/or cross-linking reaction performed when the amorphous polyester resin A is generated.

The catalyst is not particularly limited, and may be appropriately selected depending on the intended purpose. Examples of the catalyst include dibutyl tin laurate, and dioctyl tin laurate.

«Removal of Organic Solvent»

A method for removing the organic solvent from the dispersion liquid, such as the emulsified slurry, is not particularly limited, and may be appropriately selected depending on the intended purpose. Examples of the method include: a method where an entire reaction system is gradually heated to evaporate an organic solvent inside oil droplets; and a method where a dispersion liquid is sprayed in a dry atmosphere to remove an organic solvent inside oil droplets.

«Aggregating and Fusing»

As a method for the aggregation, a known method, such as addition of an aggregating agent, and pH adjustment, may be used. When the aggregating agent is added, the aggregating agent may be added as it is. However, the aggregating agent is preferably added in the form of an aqueous solution thereof because a local increase in concentration can be avoided. Moreover, the aggregating salt is preferably gradually added while observing particle diameters of color particles.

The temperature of the dispersion liquid during aggregating is preferably a temperature around Tg of the amorphous polyester resin B. When the temperature of the dispersion liquid is too low, aggregation is not progressed very well and an efficiency is poor. When the temperature of the dispersion liquid is too high, the aggregation speed is fast, resulting in an undesirable particle size distribution, such as generation of coarse particles. When the particles reach a target particle diameter, the aggregation is stopped. As a method for stopping aggregation, a method for adding a salt having lower ionic valency than the aggregating salt or a chelating agent, a method for adjusting pH, a method for lowering a temperature of a dispersion liquid, or a method for adding a large amount of an aqueous medium to reduce a concentration may be used. According to any of the above-mentioned methods, a dispersion liquid of aggregated color particles can be obtained.

In the aggregating step, a release agent may be added, or the crystalline polyester resin C may be added impart low temperature fixability. In this case, a dispersion liquid, in which the release agent is dispersed in an aqueous medium, or a dispersion liquid, in which the crystalline polyester resin C is dispersed in an aqueous medium, is prepared, and the prepared dispersion liquid is mixed with the color particle dispersion liquid, followed by aggregating, to thereby obtain aggregated particles, in which the release agent or crystalline polyester resin is uniformly dispersed.

Next, a heat treatment is performed on the obtained aggregated particles to fuse the aggregated particles to reduce surface irregularity of the aggregated particles. In order to fuse the aggregated particles, the dispersion liquid of the aggregated color particles is heated with stirring. The temperature of the dispersion liquid is preferably Tg of the amorphous polyester resin B or higher, but Tg+20° C. or lower, and more preferably Tg or higher but Tg+10° C. or lower. When the temperature thereof is greater than Tg+20° C., the compatibility between the amorphous polyester resin and the crystalline polyester resin becomes excessive, a major axis of the domain becomes large during recrystallization of the crystalline polyester resin, and therefore the crystalline polyester resin may be exposed to a surface of a toner base particle.

Thereafter, washing, drying, etc. can be performed on the toner base particles, and classification etc. may be further performed. The classification may be performed by removing a fine particle component by cyclon in a liquid, a decanter, or centrifugation. Alternatively, an operation of the classification may be performed after drying.

«Mixing Step»

The obtained toner base particles are mixed with the external additives. During the mixing, mechanical impact may be applied to prevent particles, such as the external additives, from falling off from surfaces of the toner base particles.

A method for applying mechanical impact is not particularly limited, and may be appropriately selected depending on the intended purpose. Examples thereof include: a method where impact is applied to the mixture using a blade that is rotated at high speed; and a method where the mixture is added in a high-speed air flow to accelerate to allow the particles to crush with one another, or against a collision plate.

A device used for the above-mentioned method is not particularly limited, and may be appropriately selected depending on the intended purpose. Examples thereof include an angmill (available from HOSOKAWA MICRON CORPORATION), a device obtained by modifying an I-type mill (available from Nippon Pneumatic Mfg. Co., Ltd.) to reduce pulverization air pressure, a hybridization system (available from NARA MACHINERY CO., LTD.), Kryptron System (available from Kawasaki Heavy Industries, Ltd.), and an automatic mortar.

(Developer)

The developer of the present disclosure includes at least the toner, and may further include appropriately selected other components, such as a carrier, according to the necessity.

Therefore, the developer can achieve excellent transfer performance, and chargeability, and can stably form a high quality image. The developer may be a one-component developer or two-component developer. In the case where the developer is used for a high-speed printer corresponding to a recent improvement of information processing speed, use of a two-component developer is preferable considering an improvement of service life.

When the developer is used as a one-component developer, there is no change or a slight change in the particle diameter of the toner even after consuming and refilling the toner, filming of the toner to a developing roller or fusion of the toner to a member, such as a blade for thinning a layer of the toner, is rarely caused, and excellent and stable developing properties and images are obtained even after the developer is stirred for a long period in a developing device.

When the developer is used as a two-component developer, there is no change or a slight change in the particle diameter of the toner even after consuming and refilling the toner, and excellent and stable developing properties and images are obtained even after the developer is stirred for a long period in a developing device.

<Carrier>

The carrier is not particularly limited, and may be appropriately selected depending on the intended purpose. The carrier is preferably a carrier including carrier particles each including a core and a resin layer covering the core.

«Cores»

A material of the cores is not particularly limited, and may be appropriately selected depending on the intended purpose. Examples of the material of the cores include a manganese-strontium-based material of from 50 emu/g through 90 emu/g, and a manganese-magnesium-based material of from 50 emu/g through 90 emu/g. In order to ensure a desired image density, moreover, a high magnetic material, such as iron powder of 100 emu/g or greater and magnetite of from 75 emu/g through 120 emu/g is preferably used. Moreover, a low magnetic material, such as a copper/zinc-based material of from 30 emu/g through 80 emu/g is preferably used, because an impact of the developer in the form of a brush to the photoconductor can be weakened, and a high quality image can be formed.

The above-listed examples may be used alone or in combination.

The volume average particle diameter of the cores is not particularly limited, and may be appropriately selected depending on the intended purpose. The volume average particle diameter thereof is preferably 10 micrometers or greater but 150 micrometers or less, and more preferably 40 micrometers or greater but 100 micrometers or less. When the volume average particle diameter of the cores is 10 micrometers or greater, a problem that the amount of fine powder increases in the carrier to reduce magnetization per particle to cause carrier scattering can be prevented. When the volume average particle diameter of the cores is 150 micrometers or less, the following problem is effectively prevented. The problem is a problem that a specific surface area is reduced to cause toner scattering, and reproducibility of a full-color image having a large solid image area, especially reproducibility of the solid image area, may be impaired.

When the toner is used for a two-component developer, the toner is used by blending with the carrier. An amount of the carrier in the two-component developer is not particularly limited, and may be appropriately selected depending on the intended purpose. The amount of the carrier is preferably 90 parts by mass or greater but 98 parts by mass or less, and more preferably 93 parts by mass or greater but 97 parts by mass or less, relative to 100 parts by mass of the two-component developer.

The developer of the present disclosure is suitably used for image formation according to various electrophotographic methods known in the art, such as a magnetic one-component developing method, a non-magnetic one-component developing method, and a two-component developing method.

(Image Forming Apparatus and Image Formation Method)

The image forming apparatus of the present disclosure includes at least an electrostatic latent image bearer, an electrostatic latent image forming unit, and a developing unit. The image forming apparatus may further include other units according to the necessity.

The image forming method of the present disclosure includes at least an electrostatic latent image forming step, and a developing step. The image forming method may further include other steps according to the necessity.

The image forming method is suitably performed by the image forming apparatus. The electrostatic latent image forming step is suitably performed by the electrostatic latent image forming unit. The developing step is suitably performed by the developing unit. The above-mentioned other steps are suitably performed by the above-mentioned other units.

<Electrostatic Latent Image Bearer>

A material, structure, and size of the electrostatic latent image bearer are not particularly limited, and may be appropriately selected from materials, structures, and sizes thereof known in the art. The material of the electrostatic latent image bearer include inorganic photoconductors (e.g., amorphous silicon and selenium) and organic photoconductors (e.g., polysilane and phthalopolymethine). Among the above-listed examples, amorphous silicon is preferable considering long service life of the resultant electrostatic latent image bearer.

As the amorphous silicon photoconductor, for example, a photoconductor including a photoconductor layer formed of α-Si obtained by heating a support to a temperature from 50° C. through 400° C., and forming a film of α-Si on the support by a film formation method, such as vacuum vapor deposition, sputtering, ion plating, thermal chemical vapor deposition (CVD), photo CVD, and plasma CVD. Among the above-listed example, a method for forming an α-Si deposition film on a support by plasma CVD, i.e., decomposing a raw material gas by direct current, high frequency waves, or microwave glow discharge is preferable.

A shape of the electrostatic latent image bearer is not particularly limited, and may be appropriately selected depending on the intended purpose. The shape thereof is preferably a cylinder. The outer diameter of the cylindrical electrostatic latent image bearer is not particularly limited, and may be appropriately selected depending on the intended purpose. The outer diameter thereof is preferably 3 mm or greater but 100 mm or less, more preferably 5 mm or greater but 50 mm or less, and particularly preferably 10 mm or greater but 30 mm or less.

<Electrostatic Latent Image Forming Unit and Electrostatic Latent Image Forming Step>

The electrostatic latent image forming unit is not particularly limited, and may be appropriately selected depending on the intended purpose, as long as the electrostatic latent image forming unit is a unit configured to form an electrostatic latent image on the electrostatic latent image bearer. Examples thereof include a unit including a charging member configured to charge a surface of the electrostatic latent image bearer, and an exposing member configured to expose the surface of the electrostatic latent image bearer to imagewise light.

The electrostatic latent image forming step is not particularly limited, and may be appropriately selected depending on the intended purpose, as long as the electrostatic latent image forming step is a step including forming an electrostatic latent image on the electrostatic latent image bearer. For example, the electrostatic latent image forming step can be performed by charging the surface of the electrostatic latent image bearer, followed by exposing the surface of the electrostatic latent image bearer to light imagewise, and the electrostatic latent image forming step can be performed by the electrostatic latent image forming unit.

«Charging Member and Charging»

The charging member is not particularly limited, and may be appropriately selected depending on the intended purpose. Examples of the charging member include: contact chargers known in the art, equipped with, for example, a conductive or semiconductive roller, brush, film, or rubber blade; and non-contact chargers utilizing corona discharge, such as corotron and scorotron.

For example, the charging can be performed by applying voltage to the surface of the electrostatic latent image bearer using the charging member.

As a shape of the charging member, the charging member may be in any shape, such

as a magnetic brush, and a fur brush, as well as a roller. The shape of the charging member may be selected depending on the specification or embodiment of the image forming apparatus.

The charging member is not limited to the above-mentioned contact charging member, but a contact charging member is preferably used because an image forming apparatus including such a charging member can reduce an amount of ozone generated from the charging member.

«Exposing Unit and Exposing»

The exposing unit is not particularly limited, and may be appropriately selected depending on the intended purpose, as long as the exposing unit is capable of exposing the surface of the electrostatic latent image bearer charged by the charging member to light in the shape of an image to be formed. Examples of the exposing unit include various exposing units, such as a copy optical exposing unit, a rod lens array exposing unit, a laser optical exposing unit, and a liquid crystal shutter optical exposing unit. A light source used for the exposing unit is not particularly limited, and may be appropriately selected depending on the intended purpose. Examples of the light source include most of light emitters, such as a fluorescent lamp, a tungsten lamp, a halogen lamp, a mercury lamp, a sodium vapor lamp, a light emitting diode (LED), a semi-conductor laser (LD), and an electroluminescent light (EL).

In order to apply only light having a desired wavelength range, moreover, various filters, such as a sharp-cut filter, a band-pass filter, a near infrared ray-cut filter, a dichroic filter, an interference filter, and a color temperature conversion filter, may be used.

For example, the exposing may be performed by exposing the surface of the electrostatic latent image bearer to imagewise light using the exposing unit.

In the present disclosure, a back-exposure system may be employed. The back-exposure system is a system where imagewise light exposure is performed from the back side of the electrostatic latent image bearer.

<Developing Unit and Developing Step>

The developing unit is not particularly limited, and may be appropriately selected depending on the intended purpose, as long as the developing unit stores a toner, and is configured to develop the electrostatic latent image formed on the electrostatic latent image bearer with the toner to form a visible image.

The developing step is not particularly limited, and may be appropriately selected depending on the intended purpose, as long as the developing step is a step including developing the electrostatic latent image formed on the electrostatic latent image bearer with a toner to form a visible image. For example, the developing step may be performed by the developing unit.

The developing unit may employ a dry developing system or a wet developing system. Moreover, the developing unit may be a developing unit for a single color, or a developing unit for multiple colors.

The developing unit is preferably a developing device including a stirrer configured to stir the toner to charge the toner with friction, and a developer bearer that includes a magnetic field generating unit fixed inside of the developer bearer, is configured to bear a developer including the toner on a surface thereof, and is rotatable.

Inside the developing unit, for example, the toner and the carrier are mixed and stirred to charge the toner with friction, and the charged toner is held on the surface of the rotating magnetic roller in the form of a brush to form a magnetic brush. The magnetic roller is disposed near the electrostatic latent image bearer. Therefore, part of the toner constituting the magnetic brush formed on the surface of the magnetic roller is moved onto the surface of the electrostatic latent image bearer by electric suction force. As a result, the electrostatic latent image is developed with the toner to form a visible image on the surface of the electrostatic latent image bearer with the toner.

<Other Units and Other Steps>

Examples of the above-mentioned other units include a transferring unit, a fixing unit, a cleaning unit, a charge-eliminating unit, a recycling unit, and a controlling unit. Examples of the above-mentioned other steps include a transferring step, a fixing step, a cleaning step, a charge-eliminating step, a recycling step, and a controlling step.

«Transferring Unit and Transferring Step»

The transferring unit is not particularly limited, and may be appropriately selected depending on the intended purpose, as long as the transferring unit is a unit configured to transfer the visible image onto a recording medium. Among embodiments of the transferring unit, an embodiment thereof including a first transferring unit and a second transferring unit is preferable, where the first transferring unit is configured to transfer the visible images onto an intermediate transfer member to form a composite transfer image, and the second transferring unit is configured to transfer the composite transfer image onto a recording medium.

The transferring step is not particularly limited, and may be appropriately selected depending on the intended purpose, as long as the transferring step is a step including transferring the visible image onto a recording medium. Among embodiments of the transferring step, an embodiment thereof including primary transferring visible images onto an intermediate transfer member, followed by secondary transferring the visible images onto a recording medium is preferable.

For example, the transferring step can be performed by charging the photoconductor with a transfer charger to charge the visible image, and the transferring step can be performed by the transferring unit.

When an image secondary transferred onto the recording medium is a color image composed of multiple color toners, toners of several colors are sequentially superimposed on the intermediate transfer member by the transferring unit to form an image on the intermediate transfer member, and the image on the intermediate transfer member is collectively secondary transferred onto the recording medium by the intermediate transfer member.

The intermediate transfer member is not particularly limited and may be appropriately selected from known transfer members according to the intended purpose. For example, a transfer belt is preferably used as the intermediate transfer member.

The transferring unit (e.g., the primary transferring unit, and the secondary transferring unit) preferably includes at least a transferor configured to charge the visible image formed on the photoconductor to release the visible image from the electrostatic latent image bearer to the side of a recording medium. Examples of the transferor include a corona transferor using corona discharge, a transfer belt, a transfer roller, a press transfer roller, and an adhesion transferor.

The recording medium is typically plane paper, and the recording medium is not particularly limited as long as the recording medium is a medium to which an unfixed image after developing can be transferred. The recording medium may be appropriately selected depending on the intended purpose. A PET base for OHP may be also used as the recording medium.

«Fixing Unit and Fixing Step»

The fixing unit is not particularly limited, and may be appropriately selected depending on the intended purpose, as long as the fixing unit is a unit configured to fix the transfer image transferred onto the recording medium. The fixing unit is preferably a known heat press member. Examples of the heat press member include a combination of a heating roller and a press roller, and a combination of a heat roller, a press roller, and an endless belt.

The fixing step is not particularly limited, and may be appropriately selected depending on the intended purpose, as long as the fixing step is a step including fixing the visible image transferred onto the recording medium. For example, the fixing step may be performed every time the toner of each color is transferred onto the recording medium, or the fixing step may be performed once in a state where the toners of all colors are laminated.

The fixing step can be performed by the fixing unit.

Heating by the press heat member is typically performed at 80° C. or greater but 200° C. or less.

In the present disclosure, for example, a known optical fixing device may be used in combination with or instead of the fixing unit according to the intended purpose.

The surface pressure applied during the fixing step is not particularly limited, and may be appropriately selected depending on the intended purpose. The surface pressure is preferably 10 N/cm² or greater but 80 N/cm² or less.

«Cleaning Unit and Cleaning Step»

The cleaning unit is not particularly limited, and may be appropriately selected depending on the intended purpose, as long as the cleaning unit is a unit capable of removing the toner remained on the photoconductor. Examples of the cleaning unit include a magnetic brush cleaner, an electrostatic brush cleaner, a magnetic roller cleaner, a blade cleaner, a brush cleaner, and a web cleaner.

The cleaning step is not particularly limited, and may be appropriately selected depending on the intended purpose, as long as the cleaning step is a step including removing the toner remained on the photoconductor. For example, the cleaning step can be performed by the cleaning unit.

«Charge-Eliminating Unit and Charge-Eliminating Step»

The charge-eliminating unit is not particularly limited, and may be appropriately selected depending on the intended purpose, as long as the charge-eliminating unit is a unit configured to apply charge-eliminating bias to the photoconductor to eliminate the charge of the photoconductor. Examples of the charge-eliminating unit include a charge-eliminating lamp.

The charge-eliminating step is not particularly limited, and may be appropriately selected depending on the intended purpose, as long as the charge-eliminating step is a step including applying charge-eliminating bias to the photoconductor to eliminate the charge of the photoconductor. For example, the charge-eliminating step can be performed by the charge-eliminating unit.

«Recycling Unit and Recycling Step»

The recycling unit is not particularly limited, and may be appropriately selected depending on the intended purpose, as long as the recycling unit is a unit configured to recycle the toner removed by the cleaning step to the developing device. Examples of the recycling unit include known conveying units.

The recycling step is not particularly limited, and may be appropriately selected depending on the intended purpose, as long as the recycling step is a step including recycling the toner removed by the cleaning step to the developing device. For example, the recycling step can be performed by the recycling unit.

«Controlling Unit and Controlling Step»

The controlling unit is not particularly limited, and may be appropriately selected depending on the intended purpose, as long as the controlling unit is a unit configured to control the operation of each of the above-mentioned units. Examples of the controlling unit include a sequencer, and a computer.

The controlling step is not particularly limited, and may be appropriately selected depending on the intended purpose, as long as the controlling step is a step including controlling the operation of each of the above-mentioned steps. For example, the controlling step can be performed by the controlling unit.

Next, one embodiment of a method for forming an image using the image forming apparatus of the present disclosure will be described with reference to FIG. 2. The color image forming apparatus 100A illustrated in FIG. 2 includes a photoconductor drum 10 (may be referred to as a “photoconductor 10” hereinafter) serving as the electrostatic latent image bearer, a charging roller 20 serving as the charging unit, an exposure device 30 serving as the exposing unit, a developing device 40 serving as the developing unit, an intermediate transfer member 50, a cleaning device 60 serving as the cleaning unit including a cleaning blade, and a charge-eliminating lamp 70 serving as the charge-eliminating unit.

The intermediate transfer member 50 is an endless belt supported by 3 rollers 51 disposed inside the loop of the intermediate transfer member 50, and can move in the direction indicated with the arrow in FIG. 2. Part of the 3 rollers 51 also functions as a transfer bias roller capable of applying the predetermined transfer bias (i.e., primary transfer bias) to the intermediate transfer member 50. The cleaning device 90 including the cleaning blade is disposed near the intermediate transfer member 50. Moreover, the transfer roller 80 is disposed near the intermediate transfer member 50 to face the intermediate transfer member 50, and the transfer roller 80 is capable of applying transfer bias (i.e., secondary transfer bias) for transferring (i.e., secondary transferring) the developed image (i.e., the toner image) onto transfer paper 95 serving as a recording medium. At the periphery of the intermediate transfer member 50, a corona charger 58 configured to apply charge to the toner image on the intermediate transfer member 50 is disposed between a contact area between the photoconductor 10 and the intermediate transfer member 50 and a contact area between the intermediate transfer member 50 and the transfer paper 95 along the rotational direction of the intermediate transfer member 50.

The developing device 40 includes a developing belt 41 serving as the developer bearer, and a black developing unit 45K, a yellow developing unit 45Y, a magenta developing unit 45M, and a cyan developing unit 45C disposed together at the periphery of the developing belt 41. The black developing unit 45K includes a developer storage unit 42K, a developer supply roller 43K, and a developing roller 44K. The yellow developing unit 45Y includes a developer storage unit 42Y, a developer supply roller 43Y, and a developing roller 44Y. The magenta developing unit 45M includes a developer storage unit 42M, a developer supply roller 43M, and a developing roller 44M. The cyan developing unit 45C includes a developer storage unit 42C, a developer supply roller 43C, and a developing roller 44C. Moreover, the developing belt 41 is an endless belt rotatably supported by a plurality of belt rollers, and part of the developing belt 41 is in contact with the electrostatic latent image bearer 10.

In the color image forming apparatus 100A illustrated in FIG. 2, for example, the charging roller 20 uniformly charges the photoconductor drum 10. The photoconductor drum 10 is exposed to light imagewise by the exposure device 30 to form an electrostatic latent image pm the photoconductor drum 10. The electrostatic latent image formed on the photoconductor drum 10 is developed with the toner supplied from the developing device 40 to form a toner image. Voltage is applied to the toner image by the roller 51 to transfer (primary transfer) the toner image onto the intermediate transfer member 50, followed by transferring (secondary transferring) onto transfer paper 95. As a result, a transfer image is formed on the transfer paper 95. The toner remained on the photoconductor 10 is removed by the cleaning device 60, and the residual charge of the photoconductor 10 is eliminated by the charge-eliminating lamp 70.

FIG. 3 illustrates another example of the image forming apparatus of the present disclosure. The image forming apparatus 100B has the structure identical to the structure of the image forming apparatus 100A illustrated in FIG. 2, except that the developing belt 41 is not disposed, and the black developing unit 45K, the yellow developing unit 45Y, the magenta developing unit 45M, and the cyan developing unit 45C are disposed at the periphery of the photoconductor drum 10 to directly face the photoconductor drum 10.

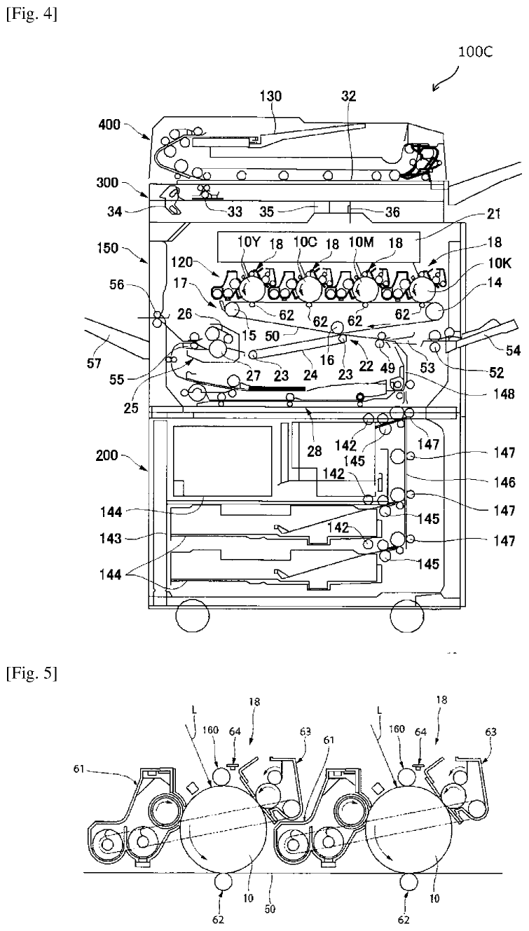

Another example of the image forming apparatus of the present disclosure is illustrated in FIG. 4. The image forming apparatus 100C illustrated in FIG. 4 includes a photocopier main body 150, a paper feeding table 200, a scanner 300, and an automatic document feeder (ADF) 400.

At the center of the photocopier main body 150, an intermediate transfer member 50, which is an endless belt, is disposed. The intermediate transfer member 50 is supported by supporting rollers 14, 15, and 16, and can move in the clockwise direction in FIG. 4. An intermediate transfer member cleaning device 17 configured to remove the toner remained on the intermediate transfer member 50 is disposed near the supporting roller 15. A tandem developing device 120, in which four image forming units 18 of yellow, cyan, magenta, and black are aligned side by side to face the intermediate transfer member 50 along the conveying direction thereof, is disposed near the intermediate transfer member supported by the supporting roller 14 and the supporting roller 15. An exposing device 21, which is an exposing unit, is disposed near the tandem developing device 120. A secondary transferring device 22 is disposed at the opposite side of the intermediate transfer member 50 to the side where the tandem developing device 120 is disposed. In the secondary transferring device 22, a secondary transfer belt 24, which is an endless belt, is supported by a pair of rollers 23, and transfer paper conveyed on the secondary transfer belt 24 comes in contact with the intermediate transfer member 50. A fixing device 25, which is the fixing unit, is disposed near the secondary transferring device 22. The fixing device 25 includes a fixing belt 26, which is an endless belt, and a press roller 27 disposed to press against the fixing belt 26. In the tandem image forming apparatus, a sheet reverser 28, which is configured to flip the side of the transfer sheet to perform image formation on the both side of the transfer paper, is disposed near the secondary transferring device 22 and the fixing device 25.

Next, formation of a full-color image (color copy) by means of the tandem developing device 120 will be described. First, a document is set on a document table 130 of the automatic document feeder (ADF) 400. Alternatively, the automatic document feeder is open, a document is set on a contact glass 32 of a scanner 300, and the automatic document feeder 400 is closed.

When the document is set on the automatic document feeder 400, the document is transported and moved onto the contact glass 32, and then a scanner 300 is driven. When the document is set on the contact glass 32, the scanner 300 is immediately driven. When the scanner 300 is driven, light emitted from a light source is applied to the document by a first carriage 33, and the light reflected from the surface of the document is reflected by a minor of a second carriage 34, and the reflected light is received by a reading sensor 36 via an image forming lens 35 to read the color document (color image) to attain image information of black, yellow, magenta, and cyan.

Each image formation of black, yellow, magenta, and cyan is transmitted to the corresponding image forming unit 18 (the black image forming unit, the yellow image forming unit, the magenta image forming unit, and the cyan image forming unit) of the tandem developing device 120. In each image forming unit, each toner image of black, yellow, magenta, or cyan is formed.

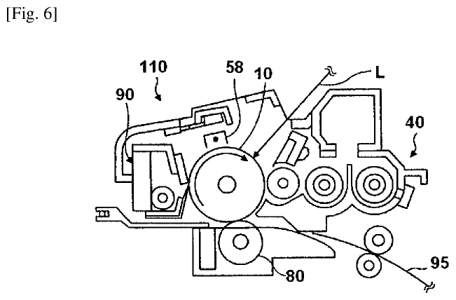

As illustrated in FIG. 5, specifically, each image forming unit 18 (the black image forming unit, the yellow image forming unit, the magenta image forming unit, or the cyan image forming unit) in the tandem developing device 120 includes an electrostatic latent image bearer 10 (a black electrostatic latent image bearer 10K, a yellow electrostatic latent image bearer 10Y, a magenta electrostatic latent image bearer 10M, or a cyan electrostatic latent image bearer 10C), a charging device 160 that is the charging unit configured to uniformly charge the electrostatic latent image bearer 10, an exposing device configured to expose the electrostatic latent image bearer to light (L in FIG. 5) corresponding to each color image to be formed based on each color image information to form an electrostatic latent image corresponding to each color image on the electrostatic latent image bearer, a developing device 61 that is the developing unit configured to develop the electrostatic latent image with each color toner (a black toner, a yellow toner, a magenta toner, or a cyan toner) to form a toner image formed of each color toner, a transfer charger 62 configured to transfer the toner image onto an intermediate transfer member 50, a cleaning device 63, and a charge-eliminating unit 64.

Each image forming unit 18 can form an image of each color (a black image, a yellow image, a magenta image, or a cyan image) based on each color image information. The black image, yellow image, magenta image, and cyan image formed in the above-described manner, i.e., the black image formed on the black electrostatic latent image bearer 10K, the yellow image formed on the yellow electrostatic latent image bearer 10Y, the magenta image formed on the magenta electrostatic latent image bearer 10M, and the cyan image formed on the cyan electrostatic latent image bearer 10C, are sequentially transferred (primary transferred) onto the intermediate transfer member 50 that is driven and rotated by the supporting rollers 14, 15, and 16. The black image, the yellow image, the magenta image, and the cyan image are superimposed on the intermediate transfer member 50 to form a composite color image (a color transfer image).

As illustrated in FIG. 4, meanwhile, one of the paper feeding rollers 142 is selectively rotated in the paper feeding table 200 to eject sheets (recording paper) from one of multiple paper feeding cassettes 144 of the paper bank 143. The sheets are separated one by one by a separation roller 145 to send each sheet to a paper feeding path 146, and then transported by a conveying roller 147 to guide into a paper feeding path 148 within the photocopier main body 150. The sheet transported in the paper feeding path 148 is than bumped against a registration roller 49 to stop. Alternatively, sheets (recording paper) on a manual feeding tray 54 is ejected by rotating the paper feeding roller 142, and the ejected sheets are separated one by one by the separation roller 52 to send to a manual paper feeding path 53. Similarly to the above, the sheet is bumped against the registration roller 49 to stop. The registration roller 49 is generally earthed at the time of use, but the registration roller 49 may be biased in order to remove paper dusts of the sheets.

The registration roller 49 is rotated synchronously with the movement of the composite color image (color transfer image) formed on the intermediate transfer member 50 to send the sheet (the recording paper) between the intermediate transfer member 50 and a secondary transferring device 22 to transfer (secondary transfer) the composite color image (the color transfer image) onto the sheet (the recording paper). The toner remained on the intermediate transfer member 50 after transferring the image is cleaned by the intermediate transfer member cleaning device 17.

The sheet (the recording paper) onto which the color image has been transferred is transported by the secondary transferring device 22 to send to the fixing device 25. The fixing device 25 applies heat and pressure to the composite color image (the color transfer image) to fix the composite color image (the color transfer image) on the sheet (the recording paper). Thereafter, the traveling path of the sheet (the recording paper) is switched by the separation craw 55 and the sheet (the recording paper) is ejected to a paper ejection tray 57 by an ejecting roller 56. Alternatively, the traveling path of the sheet is switched by the separation craw 55, and the side of the sheet is flipped by a sheet reverser 28 to guide the sheet again to the transfer position to record an image on the back side of the sheet. Thereafter, the sheet is ejected by the ejecting roller to stack on the paper ejection tray 57.

(Toner Storage Unit)

In the present disclosure, the toner storage unit includes a unit having a function of storing a toner, and a toner stored in the unit. Examples of an embodiment of the toner storage unit include a toner storage container, a developing device, and a process cartridge.

The toner storage container includes a container, and a toner stored in the container.

The developing device is a developing unit that stores a toner, and is configured to develop with the toner.

The process cartridge includes at least an image bearer and a developing unit as an integrated body, stores a toner therein, and can be detachably mounted in an image forming apparatus. The process cartridge may further include at least one selected from the group consisting of a charging unit, an exposing unit, and a cleaning unit.

When the toner storage unit of the present disclosure is mounted in an image forming apparatus to perform image formation, the image formation is performed by using the toner of the present disclosure. Therefore, both desirable cleaning performance and low temperature fixability are achieved.

The toner storage container is not particularly limited and may be appropriately selected from toner storage containers known in the art. Examples of the toner storage container include a toner storage container including a container main body and a cap.

Moreover, a size, shape, structure, material etc. of the container main body are not particularly limited and may be appropriately changed.

The shape thereof is preferably a cylinder. When a spiral groove with a convex-concave shape is formed on the inner circumferential surface of the container main body and the main body is rotated, the developer contained therein can move towards the side of the outlet. It is particularly preferable that the entire or part of spiral groove has a bellows function.

Moreover, the material of the container main body is not particularly limited, but the material thereof is preferably a material having excellent dimensional precision. Examples of the material include resin materials, such as a polyester resin, a polyethylene resin, a polypropylene resin, a polystyrene resin, a polyvinyl chloride resin, polyacrylic acid, a polycarbonate resin, an ABS resin, and a polyacetal resin.

Since the toner storage container enables easy storage and transportation, and excels in handling, the toner storage container can be detachably mounted in a process cartridge, an image forming apparatus, etc. and is used for replenishment of a toner.

An example of the process cartridge associated with the present disclosure can be detachably mounted in various image forming apparatuses. The process cartridge includes an electrostatic latent image bearer configured to bear an electrostatic latent image, and a developing unit configured to develop the electrostatic latent image born on the electrostatic latent image bearer with the developer of the present disclosure to form a toner image. The process cartridge of the present disclosure may further include other units according to the necessity.

The developing unit includes at least a developer storage container storing the developer of the present disclosure, and a developer bearing member configured to bear the developer stored inside the developer storage container and transport the developer. The developing unit may further include a regulating member configured to regulate a thickness of the born developer.

FIG. 6 illustrates an example of the process cartridge associated with the present disclosure. The process cartridge 110 includes a photoconductor drum 10, a corona discharger 58, a developing device 40, a transfer roller 80, and a cleaning device 90. In FIG. 6, the numerical reference 95 is recording paper.

### EXAMPLES

The present disclosure will be described more specifically below by way of Examples. The present disclosure should not be construed as being limited to these Examples. In Examples, “part(s)” denotes “part(s) by mass” and “%” denotes “% by mass” unless otherwise stated.

In Examples below, each measurement value was measured by the method described in the present specification. Tg and a molecular weight of an amorphous polyester resin A, an amorphous polyester resin B, a crystalline polyester resin C etc. were measured from each resin obtained in Production Examples.

### Production Example 1

### Synthesis of Ketimine

A reaction vessel equipped with a stirring rod and a thermometer was charged with 170 parts of isophoronediamine and 75 parts of methyl ethyl ketone, and the resultant mixture was allowed to react for 5 hours at 50° C. to thereby obtain [Ketimine Compound 1]. [Ketimine Compound 1] had an amine value of 418 mgKOH/g.

### Production Example A-1

### Synthesis of Amorphous Polyester Resin A-1

### Synthesis of Prepolymer A-1

A reaction vessel equipped with a cooling tube, a stirrer, and a nitrogen-inlet tube was charged with 3-methyl-1,5-pentanediol, isophthalic acid, and plant-derived sebacic acid together with titanium tetraisopropoxide (1,000 ppm relative to the resin component) in a manner that a molar ratio OH/COOH of the hydroxyl groups to the carboxyl group was to be 1.1, the diol component included 100 mol % of 3-methyl-1,5-pentanediol, the dicarboxylic acid component included 66 mol % of isophthalic acid and 34 mol % of sebacic acid, and an amount of the trimethylolpropane relative to the total amount of the monomers was to be 1.5 mol %. The resultant mixture was heated to 200° C. for about 4 hours, then heated to 230° C. for 2 hours, and the reaction was carried out until no effluent was discharged. Thereafter, the resultant was allowed to react for 5 hours under the reduced pressure of from 10 mmHg through 15 mmHg, to thereby obtain [Intermediate Polyester A-1].

Next, a reaction vessel equipped with a cooling tuber, a stirrer, and a nitrogen-inlet tube was charged with [Intermediate Polyester A-1] obtained and isophorone diisocyanate (IPDI) at a molar ratio (isocyanate groups of IPDI/hydroxyl groups of intermediate polyester) of 2.0. After diluting the resultant mixture with ethyl acetate to form a 50% ethyl acetate solution, the resultant solution was allowed to react for 5 hours at 100° C., to thereby obtain [Prepolymer A-1].

### Synthesis of Amorphous Polyester Resin A-1

[Prepolymer A-1] obtained was stirred in a reaction vessel equipped with a heater, a stirrer, and a nitrogen-inlet tube. To the reaction vessel, an amount of [Ketimine Compound 1] that made the amount of the amine of [Ketimine Compound 1] equimolar to the amount of isocyanate in [Prepolymer A-1] was added by dripping. After stirring for 10 hours at 45° C., an elongation product of the prepolymer was taken out. The obtained elongation product of the prepolymer was vacuum dried at 50° C. until the residual ethyl acetate content was to be 100 ppm or less, to thereby obtain [Amorphous Polyester Resin A-1]. The physical properties of [Amorphous Polyester Resin A-1] are presented in Table 1.

### Production Example A-2

### Synthesis of Amorphous Polyester Resin A-2

### Synthesis of Prepolymer A-2

A reaction vessel equipped with a cooling tube, a stirrer, and a nitrogen-inlet tube was charged with 3-methyl-1,5-pentanediol, isophthalic acid, and plant-derived sebacic acid together with titanium tetraisopropoxide (1,000 ppm relative to the resin component) in a manner that a molar ratio OH/COOH of the hydroxyl groups to the carboxyl group was to be 1.1, the diol component included 100 mol % of 3-methyl-1,5-pentanediol, the dicarboxylic acid component included 83 mol % of isophthalic acid and 17 mol % of sebacic acid, and an amount of the trimethylolpropane relative to the total amount of the monomers was to be 1.5 mol %. The resultant mixture was heated to 200° C. for about 4 hours, then heated to 230° C. for 2 hours, and the reaction was carried out until no effluent was discharged. Thereafter, the resultant was allowed to react for 5 hours under the reduced pressure of from 10 mmHg through 15 mmHg, to thereby obtain [Intermediate Polyester A-2].

Next, a reaction vessel equipped with a cooling tuber, a stirrer, and a nitrogen-inlet tube was charged with [Intermediate Polyester A-2] obtained and isophorone diisocyanate (IPDI) at a molar ratio (isocyanate groups of IPDI/hydroxyl groups of intermediate polyester) of 2.0. After diluting the resultant mixture with ethyl acetate to form a 50% ethyl acetate solution, the resultant solution was allowed to react for 5 hours at 100° C., to thereby obtain [Prepolymer A-2].

### Synthesis of Amorphous Polyester Resin A-2

[Prepolymer A-2] obtained was stirred in a reaction vessel equipped with a heater, a stirrer, and a nitrogen-inlet tube. To the reaction vessel, an amount of [Ketimine Compound 1] that made the amount of the amine of [Ketimine Compound 1] equimolar to the amount of isocyanate in [Prepolymer A-2] was added by dripping. After stirring for 10 hours at 45° C., an elongation product of the prepolymer was taken out. The obtained elongation product of the prepolymer was vacuum dried at 50° C. until the residual ethyl acetate content was to be 100 ppm or less, to thereby obtain [Amorphous Polyester Resin A-2]. The physical properties of [Amorphous Polyester Resin A-2] are presented in Table 1.

### Production Example A-3

### Synthesis of Amorphous Polyester Resin A-3

### Synthesis of Prepolymer A-3

A reaction vessel equipped with a cooling tube, a stirrer, and a nitrogen-inlet tube was charged with 3-methyl-1,5-pentanediol, isophthalic acid, and adipic acid together with titanium tetraisopropoxide (1,000 ppm relative to the resin component) in a manner that a molar ratio OH/COOH of the hydroxyl groups to the carboxyl group was to be 1.1, the diol component included 100 mol % of 3-methyl-1,5-pentanediol, the dicarboxylic acid component included 50 mol % of isophthalic acid and 50 mol % of adipic acid, and an amount of the trimethylolpropane relative to the total amount of the monomers was to be 1.5 mol %. The resultant mixture was heated to 200° C. for about 4 hours, then heated to 230° C. for 2 hours, and the reaction was carried out until no effluent was discharged. Thereafter, the resultant was allowed to react for 5 hours under the reduced pressure of from 10 mmHg through 15 mmHg, to thereby obtain [Intermediate Polyester A-3].

Next, a reaction vessel equipped with a cooling tuber, a stirrer, and a nitrogen-inlet tube was charged with [Intermediate Polyester A-3] obtained and isophorone diisocyanate (IPDI) at a molar ratio (isocyanate groups of IPDI/hydroxyl groups of intermediate polyester) of 2.0. After diluting the resultant mixture with ethyl acetate to form a 50% ethyl acetate solution, the resultant solution was allowed to react for 5 hours at 100° C., to thereby obtain [Prepolymer A-3].

### Synthesis of Amorphous Polyester Resin A-3

[Prepolymer A-3] obtained was stirred in a reaction vessel equipped with a heater, a stirrer, and a nitrogen-inlet tube. To the reaction vessel, an amount of [Ketimine Compound 1] that made the amount of the amine of [Ketimine Compound 1] equimolar to the amount of isocyanate in [Prepolymer A-3] was added by dripping. After stirring for 10 hours at 45° C., an elongation product of the prepolymer was taken out. The obtained elongation product of the prepolymer was vacuum dried at 50° C. until the residual ethyl acetate content was to be 100 ppm or less, to thereby obtain [Amorphous Polyester Resin A-3]. The physical properties of [Amorphous Polyester Resin A-3] are presented in Table 1.

TABLE 1

| | | | Dicarboxylic | Tg | |
|---|---|---|---|---|---|
| | Type | Diol | acid | [° C.] | Mw |
| Amorphous | A-1 | 3-methyl-1,5- | isophthalic | −43 | 17,000 |
| polyester | | pentanediol 100% | acid 66%/ | | |
| resin A | | | plant-derived | | |
| | | | sebacic | | |
| | | | acid 34% | | |
| | A-2 | 3-methyl-1,5- | isophthalic | −55 | 17,500 |
| | | pentanediol 100% | acid 83%/ | | |
| | | | plant-derived | | |
| | | | sebacic | | |
| | | | acid 17% | | |
| | A-3 | 3-methyl-1,5- | isophthalic | −40 | 16,400 |
| | | pentanediol 100% | acid 45%/ | | |
| | | | adipic | | |
| | | | acid 55% | | |

### Production Example B-1

### Synthesis of Amorphous Polyester Resin B-1

A four-necked flask equipped with a nitrogen-inlet tube, a dehydration tube, a stirrer, and a thermocouple was charged with plant-derived propylene glycol, terephthalic acid, and plant-derived succinic acid in a manner that a molar ratio (terephthalic acid/succinic acid) of terephthalic acid to succinic acid was to be 86/14 and a molar ratio OH/COOH of hydroxyl groups to carboxyl groups was to be 1.3. The resultant mixture was allowed to react together with titanium tetraisopropoxide (500 ppm relative to the resin component) for 8 hours at 230° C. under atmospheric pressure, followed by reacting for 4 hours under the reduced pressure of from 10 mmHg through 15 mmHg. Thereafter, trimellitic acid anhydride was added to the reaction vessel in a manner that an amount of the trimellitic acid anhydride was to be 1 mol % relative to a total amount of the resin component, and the resultant mixture was allowed to react for 3 hours at 180° C. under the atmospheric pressure, to thereby obtain [Amorphous Polyester Resin B-1]. The physical properties of the resin are presented in Table 2.

### Production Example B-2

### Synthesis of Amorphous Polyester Resin B-2

A four-necked flask equipped with a nitrogen-inlet tube, a dehydration tube, a stirrer, and a thermocouple was charged with propylene glycol, a bisphenol A propylene oxide (2 mol) adduct, terephthalic acid, and plant-derived succinic acid in a manner that a molar ratio (propylene glycol/bisphenol A ethylene oxide (2 mol) adduct) of propylene glycol to the bisphenol A ethylene oxide (2 mol) adduct was to be 60/40, a molar ratio (terephthalic acid/succinic acid) of terephthalic acid to succinic acid was to be 86/14, and a molar ratio OH/COOH of hydroxyl groups to carboxyl groups was to be 1.3. The resultant mixture was allowed to react together with titanium tetraisopropoxide (500 ppm relative to the resin component) for 8 hours at 230° C. under atmospheric pressure, followed by reacting for 4 hours under the reduced pressure of from 10 mmHg through 15 mmHg. Thereafter, trimellitic acid anhydride was added to the reaction vessel in a manner that an amount of the trimellitic acid anhydride was to be 1 mol % relative to a total amount of the resin component, and the resultant mixture was allowed to react for 3 hours at 180° C. under the atmospheric pressure, to thereby obtain [Amorphous Polyester Resin B-2]. The physical properties of the resin are presented in Table 2.

### Production Example B-3

### Synthesis of Amorphous Polyester Resin B-3

A four-necked flask equipped with a nitrogen-inlet tube, a dehydration tube, a stirrer, and a thermocouple was charged with a bisphenol A ethylene oxide (2 mol) adduct, a bisphenol A propylene oxide (2 mol) adduct, terephthalic acid, and adipic acid in a manner that a molar ratio (bisphenol A propylene oxide (2 mol) adduct/bisphenol A ethylene oxide (2 mol) adduct) of the bisphenol A propylene oxide (2 mol) adduct to the bisphenol A ethylene oxide (2 mol) adduct was to be 60/40, a molar ratio (terephthalic acid/adipic acid) of terephthalic acid to adipic acid was to be 97/3, and a molar ratio OH/COOH of hydroxyl groups to carboxyl groups was to be 1.3. The resultant mixture was allowed to react together with titanium tetraisopropoxide (500 ppm relative to the resin component) for 8 hours at 230° C. under atmospheric pressure, followed by reacting for 4 hours under the reduced pressure of from 10 mmHg through 15 mmHg. Thereafter, trimellitic acid anhydride was added to the reaction vessel in a manner that an amount of the trimellitic acid anhydride was to be 1 mol % relative to a total amount of the resin component, and the resultant mixture was allowed to react for 3 hours at 180° C. under the atmospheric pressure, to thereby obtain [Amorphous Polyester Resin B-3]. The physical properties of the resin are presented in Table 2.

TABLE 2

| | | | Dicarboxylic | Tg | |
|---|---|---|---|---|---|
| | Type | Diol | acid | [° C.] | Mw |
| Amorphous | B-1 | propylene glycol | terephthalic | 55 | 9,000 |
| polyester | | | acid 86%/ | | |
| resin B | | | plant-derived | | |
| | | | succinic | | |
| | | | acid 14% | | |
| | B-2 | propylene glycol | terephthalic | 54 | 10,000 |
| | | 60%/bisphenol A | acid 86%/ | | |
| | | ethylene oxide 2 | plant-derived | | |
| | | mol adduct 40% | succinic | | |
| | | | acid 14% | | |
| | B-3 | bisphenol A | terephthalic | 67 | 8,000 |
| | | propylene oxide | acid 97%/ | | |
| | | 2 mol adduct | adipic | | |
| | | 60%/bisphenol A | acid 3% | | |
| | | ethylene oxide | | | |
| | | 2 mol adduct 40% | | | |

### Production Example C-1

### Synthesis of Crystalline Polyester Resin C-1

A 5 L four-necked flask equipped with a nitrogen-inlet tube, a dehydration tube, a stirrer, and a thermocouple was charged with plant-derived sebacic acid, and 1,6-hexanediol in a manner that a molar ratio OH/COOH of hydroxyl groups to carboxyl groups was to be 0.9. The resultant mixture was allowed to react together with titanium tetraisopropoxide (500 ppm relative to the resin component) for 10 hours at 180° C., followed by heating to 200° C. and reacting for 3 hours. The resultant was further allowed to react for 2 hours at the pressure of 8.3 kPa, to thereby obtain [Crystalline Polyester Resin C-1]. The values of the physical properties of the resin are presented in Table 3.

### Production Example C2

### Synthesis of Crystalline Polyester Resin C-2

[Crystalline Polyester Resin C-2] was synthesized in the same manner as the synthesis of [Crystalline Polyester Resin C-1], except that the dicarboxylic acid was replaced with plant-derived dodecanedioic acid. The values of the physical properties of the resin are presented in Table 3.

### Production Example C-3

### Synthesis of Crystalline Polyester Resin C-3

[Crystalline Polyester Resin C-3] was synthesized in the same manner as the synthesis of [Crystalline Polyester Resin C-1], except that the diol was replaced with plant-derived ethylene glycol. The values of the physical properties of the resin are presented in Table 3.

### Production Example C-4

### Synthesis of Crystalline Polyester Resin C-4

[Crystalline Polyester Resin C-4] was synthesized in the same manner as the synthesis of [Crystalline Polyester Resin C-1], except that the dicarboxylic acid was replaced with adipic acid. The values of the physical properties of the resin are presented in Table 3.

### Production Example C-5

### Synthesis of Crystalline Polyester Resin C-5

[Crystalline Polyester Resin C-5] was synthesized in the same manner as the synthesis of [Crystalline Polyester Resin C-1], except that the diol was replaced with 1,8-octanediol, and the dicarboxylic acid was replaced with plant-derived tetradecanoic acid. The values of the physical properties of the resin are presented in Table 3.

TABLE 3

| | | | Dicarboxylic | Tm | |
|---|---|---|---|---|---|
| | Type | Diol | acid | [° C.] | Mw |
| Crystalline | C-1 | 1,6-hexane- | plant-derived | 67 | 25,000 |
| polyester | | diol 100% | sebacic | | |
| resin C | | | acid 100% | | |
| | C-2 | 1,6-hexane- | plant-derived | 70 | 15,000 |
| | | diol 100% | dodecanedioic | | |
| | | | acid 100% | | |
| | C-3 | plant-derived | plant-derived | 72 | 20,000 |
| | | ethylene | sebacic | | |
| | | glycol 100% | acid 100% | | |
| | C-4 | 1,6-hexane- | adipic acid | 60 | 25,000 |
| | | diol 100% | 100% | | |
| | C-5 | 1,8-octane- | plant-derived | 90 | 20,000 |
| | | diol 100% | dodecanedioic | | |
| | | | acid 100% | | |

### Preparation of master batch (MB)

Water (1,200 parts), 500 parts of carbon black (product name: Printex35, available from Degussa, DBP oil absorption: 42 mL/100 mg, pH: 9.5), and 500 parts of [Amorphous Polyester Resin B-1] were added together, and the resultant mixture was mixed by means of HENSCHEL MIXER (available from Nippon Cole & Engineering Co., Ltd.). After kneading the mixture for 30 minutes at 150° C. using a twin-roll kneader, the resultant kneaded product was rolled and cooled, followed by pulverizing the resultant by a pulverizer to thereby obtain [Master Batch 1].

<Production of Wax Dispersion Liquid 1>

A vessel equipped with a stirring rod and a thermometer was charged with 42 parts of carnauba wax (vegetable wax, RN-5, available from CERARICA NODA Co., Ltd., melting point: 82° C.) as [Release Agent 1], and 420 parts of ethyl acetate. The resulting mixture was heated at 80° C. with stirring, and the temperature was maintained at 80° C. for 5 hours, followed by cooling to 30° C. for 1 hour. The resultant was dispersed by means of a bead mill (ULTRA VISCOMILL, available from AIMEX CO., LTD.) under the conditions that the feeding rate was 1 kg/hr, the disk rim speed was 6 msec, zirconia beads each having a diameter of 0.5 mm were packed in the amount of 80% by volume, and the number of passes was 3, to thereby obtain [Wax Dispersion Liquid 1]. The volume average particle diameter of the obtained wax particles was 420 nm, and the concentration of the solids, i.e., the wax particles, in [Wax Dispersion Liquid 1] was 10%.

<Production of Wax Dispersion Liquid 2>

To 720 parts of ion-exchanged water, 180 parts of ester wax (synthetic wax of plant-derived monomers, WE-11, available from NOF CORPORATION, melting point: 67° C.) as [Release Agent 2], and 17 parts of an anionic surfactant (sodium dode-cylbenzene sulfonate, NEOGEN SC, available from DKS Co., Ltd.) as a surfactant were added. The resultant mixture was dispersed by a homogenizer with heating at 90° C., to thereby obtain [Wax Dispersion Liquid 2]. The volume average particle diameter of the obtained wax particles was 250 nm, and the concentration of the solids, i.e., the wax particles, in [Wax Dispersion Liquid 1] was 25%.

<Production of Wax Dispersion Liquid 3>

A vessel equipped with a stirring rod and a thermometer was charged with 50 parts of paraffin wax (hydrocarbon-based wax, HNP-9, available from Nippon Seiro Co., Ltd., melting point: 75° C., SP value: 8.8) as [Release Agent 3], and 450 parts of ethyl acetate. The resulting mixture was heated at 80° C. with stirring, and the temperature was maintained at 80° C. for 5 hours, followed by cooling to 30° C. for 1 hour. The resultant was dispersed by means of a bead mill (ULTRA VISCOMILL, available from AIMEX CO., LTD.) under the conditions that the feeding rate was 1 kg/hr, the disk rim speed was 6 msec, zirconia beads each having a diameter of 0.5 mm were packed in the amount of 80% by volume, and the number of passes was 3, to thereby obtain [Wax Dispersion Liquid 3]. The volume average particle diameter of the obtained wax particles was 350 nm, and the concentration of the solids, i.e., the wax particles, in [Wax Dispersion Liquid 1] was 25%.

The compositions and physical properties of Wax Dispersion Liquids 1 to 3 are presented in Table 4.

TABLE 4

| | Wax | Dv of wax | Solid content |
|---|---|---|---|
| Wax Dispersion | ester wax, | 420 nm | 10% |
| Liquid 1 | synthetic wax of | | |
| | plant-derived | | |
| | monomer | | |
| Wax Dispersion | ester wax, | 250 nm | 25% |
| Liquid 2 | synthetic wax of | | |
| | plant-derived | | |
| | monomer | | |
| Wax Dispersion | paraffin wax | 350 nm | 25% |
| Liquid 3 | | | |

<Production of Crystalline Polyester Resin Dispersion Liquid 1>

A vessel equipped with a stirring rod and a thermometer was charged with 45 parts of [Crystalline Polyester Resin C-1], and 450 parts of ethyl acetate. The resulting mixture was heated at 80° C. with stirring, and the temperature was maintained at 80° C. for 5 hours, followed by cooling to 30° C. for 1 hour. The resultant was dispersed by means of a bead mill (ULTRA VISCOMILL, available from AIMEX CO., LTD.) under the conditions that the feeding rate was 1 kg/hr, the disk rim speed was 6 msec, zirconia beads each having a diameter of 0.5 mm were packed in the amount of 80% by volume, and the number of passes was 3, to thereby obtain [Crystalline Polyester Resin Dispersion Liquid 1]. The volume average particle diameter (Dv) of the obtained crystalline polyester resin particles was 350 nm, and the concentration of the solids, i.e., the crystalline polyester resin particles, in [Crystalline Polyester Resin Dispersion Liquid 1] was 10%.

<Production of Crystalline Polyester Resin Dispersion Liquid 2>

A vessel equipped with a stirring rod and a thermometer was charged with 45 parts of [Crystalline Polyester Resin C-2], and 450 parts of ethyl acetate. The resulting mixture was heated at 80° C. with stirring, and the temperature was maintained at 80° C. for 5 hours, followed by cooling to 30° C. for 1 hour. The resultant was dispersed by means of a bead mill (ULTRA VISCOMILL, available from AIMEX CO., LTD.) under the conditions that the feeding rate was 1 kg/hr, the disk rim speed was 6 msec, zirconia beads each having a diameter of 0.5 mm were packed in the amount of 80% by volume, and the number of passes was 3, to thereby obtain [Crystalline Polyester Resin Dispersion Liquid 2]. The volume average particle diameter of the obtained crystalline polyester resin particles was 350 nm, and the concentration of the solids, i.e., the crystalline polyester resin particles, in [Crystalline Polyester Resin Dispersion Liquid 2] was 10%.

<Production of Crystalline Polyester Resin Dispersion Liquid 3>

A vessel equipped with a stirring rod and a thermometer was charged with 45 parts of [Crystalline Polyester Resin C-3], and 450 parts of ethyl acetate. The resulting mixture was heated at 80° C. with stirring, and the temperature was maintained at 80° C. for 5 hours, followed by cooling to 30° C. for 1 hour. The resultant was dispersed by means of a bead mill (ULTRA VISCOMILL, available from AIMEX CO., LTD.) under the conditions that the feeding rate was 1 kg/hr, the disk rim speed was 6 msec, zirconia beads each having a diameter of 0.5 mm were packed in the amount of 80% by volume, and the number of passes was 3, to thereby obtain [Crystalline Polyester Resin Dispersion Liquid 3]. The volume average particle diameter of the obtained crystalline polyester resin particles was 350 nm, and the concentration of the solids, i.e., the crystalline polyester resin particles, in [Crystalline Polyester Resin Dispersion Liquid 3] was 10%.

<Production of Crystalline Polyester Resin Dispersion Liquid 4>

A separable flask was charged with 350 parts of [Crystalline Polyester Resin C-1], 210 parts of methyl ethyl ketone, and 61.8 parts of isopropyl alcohol. The resultant mixture was sufficiently mixed and dissolved at 40° C. To the resultant solution, 16.24 parts of 10% ammonia solution was added by dripping. Then, the heating temperature was reduced to 65° C., and ion-exchanged water was added to the mixture by dripping with stirring using a feeding pump at the feeding rate of 8 g/min. After confirming the mixture became evenly cloudy, the feeding rate was increased to 12 g/min. Dripping of ion-exchanged water was stopped when the total amount of the mixture reached 1,400 parts. Thereafter, the solvent was removed under the reduced pressure, to thereby obtain [Crystalline Polyester Resin Dispersion Liquid 4]. The volume average particle diameter of the obtained crystalline polyester resin particles was 160 nm, and the concentration of the solids, i.e., the crystalline polyester resin particles, in [Crystalline Polyester Resin Dispersion Liquid 4] was 30%.

<Production of Crystalline Polyester Resin Dispersion Liquid 5>

A vessel equipped with a stirring rod and a thermometer was charged with 45 parts of [Crystalline Polyester Resin C-], and 450 parts of ethyl acetate. The resulting mixture was heated at 80° C. with stirring, and the temperature was maintained at 80° C. for 5 hours, followed by cooling to 30° C. for 1 hour. The resultant was dispersed by means of a bead mill (ULTRA VISCOMILL, available from AIMEX CO., LTD.) under the conditions that the feeding rate was 1 kg/hr, the disk rim speed was 6 msec, zirconia beads each having a diameter of 0.5 mm were packed in the amount of 80% by volume, and the number of passes was 3, to thereby obtain [Crystalline Polyester Resin Dispersion Liquid 5]. The volume average particle diameter of the obtained crystalline polyester resin particles was 340 nm, and the concentration of the solids, i.e., the crystalline polyester resin particles, in [Crystalline Polyester Resin Dispersion Liquid 5] was 10%.

<Production of Crystalline Polyester Resin Dispersion Liquid 6>

A vessel equipped with a stirring rod and a thermometer was charged with 45 parts of [Crystalline Polyester Resin C-5], and 450 parts of ethyl acetate. The resulting mixture was heated at 80° C. with stirring, and the temperature was maintained at 80° C. for 5 hours, followed by cooling to 30° C. for 1 hour. The resultant was dispersed by means of a bead mill (ULTRA VISCOMILL, available from AIMEX CO., LTD.) under the conditions that the feeding rate was 1 kg/hr, the disk rim speed was 6 msec, zirconia beads each having a diameter of 0.5 mm were packed in the amount of 80% by volume, and the number of passes was 3, to thereby obtain [Crystalline Polyester Resin Dispersion Liquid 6]. The volume average particle diameter of the obtained crystalline polyester resin particles was 340 nm, and the concentration of the solids, i.e., the crystalline polyester resin particles, in [Crystalline Polyester Resin Dispersion

Liquid 6] was 10%.

### Example 1

### Preparation of oil phase

A vessel was charged with 50 parts of [Wax Dispersion Liquid 1], 150 parts of [Amorphous Polyester Resin A-1], 50 parts of [Crystalline Polyester Resin Dispersion Liquid 1], 750 parts of [Amorphous Polyester Resin B-1], and 50 parts of [Master Batch 1] (pigment). The resultant mixture was mixed by means of TK Homomixer (available from PRIMIX Corporation) for 60 minutes at 5,000 rpm, to thereby obtain [Oil Phase 1].

The amounts of the components above are the amounts of the solids of the raw materials.

### Preparation of aqueous phase

Water (990 parts), 20 parts of sodium dodecyl sulfate, and 90 parts of ethyl acetate were mixed and stirred to thereby obtain a milky white liquid. The obtained milky white liquid was provided as [Aqueous Phase 1].

<Emulsification>

While stirring 700 parts of [Oil Phase 1] by TK Homomixer at 8,000 rpm, 20 parts of 28% ammonia water was added to [Oil Phase 1]. After mixing the resultant mixture for 10 minutes, 1,200 parts of [Aqueous Phase 1] was gradually added by dripping, to thereby obtain [Emulsified Slurry 1].

<Removal of Solvent>

A vessel equipped with a stirrer and a thermometer was charged with [Emulsified Slurry 1], and the solvent was removed from [Emulsified Slurry 1] for 180 minutes at 30° C., to thereby obtain [Solvent-Removed Slurry 1].

<Aggregation>

To [Solvent-Removed Slurry 1], 100 parts of a 3% magnesium chloride solution was added by dripping. After stirring the resultant mixture for 5 minutes, the mixture was heated to 60° C. When the particle diameters of the particles reached 5.0 micrometers, 50 parts of sodium chloride was added to terminate aggregation, to thereby obtain

[Aggregation Slurry 1].

<Fusion>

[Aggregation Slurry 1] was heated to 70° C. with stirring. When the particles reached the desired average circularity, which was 0.957, [Aggregation Slurry 1] was cooled to thereby obtain [Dispersion Slurry 1].

<Washing and Drying>

After filtering 100 parts of [Dispersion Slurry 1] under the reduced pressure, the series of the following processes (1) to (4) was performed twice, to thereby obtain

[Filtration Cake 1].
(1): To the filtration cake, 100 parts of ion-exchanged water was added. The resultant mixture was mixed by means of TK Homomixer (for 10 minutes at the rotational speed of 12,000 rpm), followed by filtering the resultant mixture.
(2): To the filtration cake of (1), 100 parts by mass of a 10% sodium hydroxide aqueous solution was added. The resultant mixture was mixed by means of TK Homomixer (for 30 minutes at the rotational speed of 12,000 rpm), followed by filtering the resultant mixture under the reduced pressure.
(3): To the filtration cake of (2), 100 parts of 10% hydrochloric acid was added. The resultant mixture was mixed by means of TK Homomixer (for 10 minutes at the rotational speed of 12,000 rpm), followed by filtering the resultant mixture.
(4): To the filtration cake of (3), 300 parts by mass of ion-exchanged water was added. The resultant mixture was mixed by means of TK Homomixer (for 10 minutes at the rotational speed of 12,000 rpm), followed by filtering the resultant mixture. [Filtration Cake 1] was dried by means of an air-circulating drier for 48 hours at 45° C. Then, the resultant was passed through a sieve with a mesh size of 75 micrometers, to thereby obtain [Toner Base Particles 1].

<External Additive Treatment>

To 100 parts of [Toner Base Particles 1], 2.0 parts of hydrophobic silica (HDK-2000, available from Clamant) serving as external additive were added and the mixture was mixed by means of HENSCHEL MIXER. The resultant was passed through a sieve of 500-mesh, to thereby obtain [Toner 1].

### Example 2

[Toner 2] was obtained in the same manner as in Example 1, except that, in <Preparation of oil phase>, [Amorphous Polyester Resin A-1] was replaced with [Amorphous Polyester Resin A-2], the amount of [Amorphous Polyester Resin B-1] was changed to 800 parts, and [Crystalline Polyester Resin Dispersion Liquid 1] was replaced with [Crystalline Polyester Resin Dispersion Liquid 2].

### Example 3

[Toner 3] was obtained in the same manner as in Example 1, except that, in <Preparation of oil phase>, the amount of [Amorphous Polyester Resin A-1] was changed to 0 parts by mass, [Amorphous Polyester Resin B-1] was replaced with [Amorphous Polyester Resin B-2], [Crystalline Polyester Resin Dispersion Liquid 1] was replaced with [Crystalline Polyester Resin Dispersion Liquid 3], and the amount of [Wax Dispersion Liquid 1] was changed to 0 parts, and in <Aggregation>, 40 parts of [Wax Dispersion Liquid 2] was initially added.

### Example 4

[Toner 4] was obtained in the same manner as in Example 1, except that, in <Preparation of oil phase>, [Amorphous Polyester Resin A-1] was replaced with

[Amorphous Polyester Resin A-3].

### Example 5

[Toner 5] was obtained in the same manner as in Example 1, except that, in <Preparation of oil phase>, [Amorphous Polyester Resin B-1] was replaced with [Amorphous Polyester Resin B-3], the amount of [Crystalline Polyester Resin Dispersion Liquid 1] was changed to 0 parts, and the amount of [Wax Dispersion Liquid 1] was changed to 0 parts, and in <Aggregation>, 50 parts of [Crystalline Polyester Resin Dispersion Liquid 4] and 50 parts of [Wax Dispersion Liquid 2] were initially added.

### Example 6

[Toner 6] was obtained in the same manner as in Example 1, except that, in <Preparation of oil phase>, [Amorphous Polyester Resin B-1] was replaced with [Amorphous Polyester Resin B-3], the amount of [Crystalline Polyester Resin Dispersion Liquid 1] was changed to 100 parts, and [Wax Dispersion Liquid 1] was replaced with [Wax Dispersion Liquid 3].

### Example 7

[Toner 7] was obtained in the same manner as in Example 1, except that, in <Preparation of oil phase>, [Amorphous Polyester Resin A-1] was replaced with [Amorphous Polyester Resin A-3], [Amorphous Polyester Resin B-1] was replaced with [Amorphous Polyester Resin B-3], and the amount of [Wax Dispersion Liquid 1] was changed to 0 parts, and in <Aggregation>, 50 parts of [Wax Dispersion Liquid 2] was initially added.

### Example 8

[Toner 8] was obtained in the same manner as in Example 1, except that, in <Preparation of oil phase>, [Amorphous Polyester Resin A-1] was replaced with [Amorphous Polyester Resin A-3], [Amorphous Polyester Resin B-1] was replaced with [Amorphous Polyester Resin B-3], the amount of [Crystalline Polyester Resin Dispersion Liquid 1] was changed to 130 parts, and [Wax Dispersion Liquid 1] was replaced with [Wax Dispersion Liquid 3].

### Example 9

[Toner 9] was obtained in the same manner as in Example 1, except that, in <Preparation of oil phase>, the amount of [Amorphous Polyester Resin A-1] was changed to 300 parts, [Amorphous Polyester Resin B-1] was replaced with [Amorphous Polyester Resin B-2], [Crystalline Polyester Resin Dispersion Liquid 1] was replaced with 100 parts of [Crystalline Polyester Resin Dispersion Liquid 3], and the amount of [Wax Dispersion Liquid 1] was changed to 0 parts, and in <Aggregation>, 40 parts of [Wax Dispersion Liquid 2] was initially added.

### Example 10

[Toner 10] was obtained in the same manner as in Example 1, except that, in <Preparation of oil phase>, [Amorphous Polyester Resin A-1] was replaced with [Amorphous Polyester Resin A-3], and [Amorphous Polyester Resin B-1] was replaced with [Amorphous Polyester Resin B-2].

### Comparative Example 1

[Toner 11] was obtained in the same manner as in Example 1, except that, in <Preparation of oil phase>, [Crystalline Polyester Resin Dispersion Liquid 1] was replaced with [Crystalline Polyester Resin Dispersion Liquid 6].

### Comparative Example 2

[Toner 12] was obtained in the same manner as in Example 1, except that, in <Preparation of oil phase>, [Amorphous Polyester Resin A-1] was replaced with [Amorphous Polyester Resin A-3], [Amorphous Polyester Resin B-1] was replaced with [Amorphous Polyester Resin B-3], and [Crystalline Polyester Resin Dispersion Liquid 1] was replaced with 20 parts of [Crystalline Polyester Resin Dispersion Liquid 6].

### Comparative Example 3

[Toner 13] was obtained in the same manner as in Example 1, except that, in <Preparation of oil phase>, [Crystalline Polyester Resin Dispersion Liquid 1] was replaced with [Crystalline Polyester Resin Dispersion Liquid 6], and [Wax Dispersion Liquid 1] was replaced with [Wax Dispersion Liquid 3].

### Comparative Example 4

[Toner 14] was obtained in the same manner as in Example 1, except that, in <Preparation of oil phase>, [Amorphous Polyester Resin B-1] was replaced with 700 parts of [Amorphous Polyester Resin B-2], and [Crystalline Polyester Resin Dispersion Liquid 1] was replaced with [Crystalline Polyester Resin Dispersion Liquid 5].

### Comparative Example 5

[Toner 15] was obtained in the same manner as in Example 1, except that, in <Preparation of oil phase>, [Crystalline Polyester Resin Dispersion Liquid 1] was replaced with 5 parts of [Crystalline Polyester Resin Dispersion Liquid 5], and in <Fusion>, the temperature was changed from 70° C. to 60° C.

### Comparative Example 6

[Toner 16] was obtained in the same manner as in Example 1, except that, in <Preparation of oil phase>, [Amorphous Polyester Resin A-1] was replaced with [Amorphous Polyester Resin A-3], [Amorphous Polyester Resin B-1] was replaced with [Amorphous Polyester Resin B-3], [Crystalline Polyester Resin Dispersion Liquid 1] was replaced with [Crystalline Polyester Resin Dispersion Liquid 5], and [Wax Dispersion Liquid 1] was replaced with [Wax Dispersion Liquid 3].

### Comparative Example 7

[Toner 17] was obtained in the same manner as in Example 1, except that, in <Preparation of oil phase>, [Amorphous Polyester Resin B-1] was replaced with [Amorphous Polyester Resin B-3], [Crystalline Polyester Resin Dispersion Liquid 1] was replaced with [Crystalline Polyester Resin Dispersion Liquid 6], and [Wax Dispersion Liquid 1] was replaced with [Wax Dispersion Liquid 2].

### Comparative Example 8

[Toner 18] was obtained in the same manner as in Example 1, except that, in <Preparation of oil phase>, [Amorphous Polyester Resin A-1] was replaced with [Amorphous Polyester Resin A-3], [Amorphous Polyester Resin B-1] was replaced with [Amorphous Polyester Resin B-3], the amount of [Crystalline Polyester Resin Dispersion Liquid 1] was changed to 1 part, and [Wax Dispersion Liquid 1] was replaced with [Wax Dispersion Liquid 3], and in <Fusion>, the temperature was changed from 70° C. to 25° C.

### Comparative Example 9

[Toner 19] was obtained in the same manner as in Example 1, except that, instead of performing <Emulsification>, 1,200 parts of [Aqueous Phase 1] was added to the container charged with [Oil Phase 1] and the resultant mixture was stirred by TK Homomixer for 20 minutes at 8,000 rpm to obtain [Emulsified Slurry 2], instead of performing <Removal of solvent>, a container equipped with a stirrer and a thermometer was charged with [Emulsified Slurry 2], the solvent was removed at 30° C. for 8 hours, followed by maturing at 45° C. for 4 hours, to thereby obtain [Dispersion Slurry 2], and <Aggregation> and <Fusion> were not performed.

The composition of the oil phase component in each of Examples and Comparative Examples, and characteristics of the steps of aggregation, emulsification, and removal of the solvent are presented in Table 5.

TABLE 5

| | | Oil phase components | | | | |
|---|---|---|---|---|---|---|
| | | | | Crystalline | | |
| | | | | polyester | | |
| Ex./ | | Amorphous | Amorphous | resin C | Wax | |
| Com. | Toner | polyester | polyester | dispersion | dispersion | Difference with |
| Ex. | No. | resin A | Pesin B | liquid | liquid | steps of Ex. 1 |
| Ex. 1 | Toner 1 | A-1 (150) | B-1 (750) | C-1 dispersion | Wax dispersion | |
| | | | | liquid 1 (50) | liquid 1 (50) | |
| Ex. 2 | Toner 2 | A-2 (150) | B-1 (800) | C-2 dispersion | Wax dispersion | |
| | | | | liquid 2 (50) | liquid 1 (50) | |
| Ex. 3 | Toner 3 | | B-2 (750) | C-3 dispersion | | Aggregation step: adding |
| | | | | liquid 3 (50) | | Wax dispersion liquid 2 (40) |
| Ex. 4 | Toner 4 | A-3 (150) | B-1 (750) | C-1 dispersion | Wax dispersion | |
| | | | | liquid 1 (50) | liquid 1 (50) | |
| Ex. 5 | Toner 5 | A-1 (150) | B-3 (750) | | | Aggregation step: adding |
| | | | | | | C-1 dispersion liquid 4 (50) and |
| | | | | | | Wax dispersion liquid 2 (50) |
| Ex. 6 | Toner 6 | A-1 (150) | B-3 (750) | C-1 dispersion | Wax dispersion | |
| | | | | liquid 1 (100) | liquid 8 (50) | |
| Ex. 7 | Toner 7 | A-3 (150) | B-3 (750) | C-1 dispersion | | Aggregation step: adding |
| | | | | liquid 1 (50) | | Wax dispersion liquid 2 (50) |
| Ex. 8 | Toner 8 | A-3 (150) | B-3 (750) | C-1 dispersion | Wax dispersion | |
| | | | | liquid 1 (130) | liquid 3 (50) | |
| Ex. 9 | Toner 9 | A-1 (150) | B-2 (750) | C-3 dispersion | | Aggregation step: adding |
| | | | | liquid 3 (100) | | Wax dispersion liquid 2 (40) |
| Ex. 10 | Toner 10 | A-3 (150) | B-2 (750) | C-1 dispersion | Wax dispersion | |
| | | | | liquid 1 (50) | liquid 1 (50) | |
| Comp. | Toner 11 | A-1 (150) | B-1 (750) | C-5 dispersion | Wax dispersion | |
| Ex. 1 | | | | liquid 6 (50) | liquid 1 (50) | |
| Comp. | Toner 12 | A-3 (150) | B-3 (750) | C-6 dispersion | Wax dispersion | |
| Ex. 2 | | | | liquid 6 (20) | liquid (50) | |
| Comp. | Toner 13. | A-1 (150) | B-1 (750) | C-5 dispersion | Wax dispersion | |
| Ex. 3 | | | | liquid 6 (50) | liquid 3 (50) | |
| Comp. | Toner 14 | A-1 (150) | B-2 (700) | C-4 dispersion | Wax dispersion | |
| Ex. 4 | | | | liquid 6 (50) | liquid 1 (50) | |
| Comp. | Toner 15 | A-1 (150) | B-1 (750) | C-4 dispersion | Wax dispersion | Fusion stop temperature: 60° C. |
| Ex. 5 | | | | liquid 5 (5) | liquid 1 (50) | |
| Comp. | Toner 16 | A-3 (150) | B-3 (750) | C-4 dispersion | Wax dispersion | |
| Ex. 6 | | | | liquid 5 (50) | liquid 3 (50) | |
| Comp. | Toner 17 | A-1 (150) | B-3 (750) | C-5 dispersion | Wax dispersion | |
| Ex. 7 | | | | liquid 6 (50) | liquid 2 (50) | |
| Comp. | Toner 18 | A-3 (150) | B-3 (750) | C-1 dispersion | Wax dispersion | Fusion stop temperature: 25° C. |
| Ex. 8 | | | | liquid 1 (1) | liquid 3 (50) | |
| Comp. | Toner 19 | A-1 (150) | B-1 (750) | C-1 dispersion | Wax dispersion | Emulsification/removal of |
| Ex. 9 | | | | liquid 1 (50) | liquid 1 (50) | solvent: the aqueous phase was |
| | | | | | | added to the oil phase, the |
| | | | | | | solvent was removed for 8 hours |
| | | | | | | at 30° C., followed by maturing for |
| | | | | | | 4 hours at 45° C. |
| | | | | | | No aggregation and fusion steps |

The major axis and aspect ratio of the crystalline polyester resin, and the carbon radioisotope ¹⁴C concentration in each toner are presented in Table 6.

TABLE 6

| | Average major | Average aspect | ¹⁴C |
|---|---|---|---|
| | axis of | ratio of | concentration |
| | domains [μm] | domains [—] | [pMC] |
| Ex. 1 | 1.6 | 12.0 | 42.6 |
| Ex. 2 | 1.2 | 7.5 | 41.2 |
| Ex. 3 | 0.8 | 5.1 | 30.0 |
| Ex. 4 | 1.5 | 11.0 | 39.2 |
| Ex. 5 | 1.5 | 10.5 | 11.8 |
| Ex. 6 | 1.4 | 11.2 | 9.4 |
| Ex. 7 | 0.8 | 4.0 | 10.8 |
| Ex. 8 | 1.6 | 10.9 | 7.8 |
| Ex. 9 | 0.9 | 5.0 | 28.8 |
| Ex. 10 | 0.9 | 5.0 | 23.8 |
| Comp. Ex. 1 | 0.3 | 1.3 | 44.5 |
| Comp. Ex. 2 | 0.4 | 1.2 | 7.4 |
| Comp. Ex. 3 | 0.3 | 1.2 | 39.4 |
| Comp. Ex. 4 | 2.1 | 7.1 | 24.0 |
| Comp. Ex. 5 | 1.9 | 9.0 | 41.2 |
| Comp. Ex. 6 | 2.1 | 7.5 | 0.0 |
| Comp. Ex. 7 | 0.3 | 1.1 | 13.7 |
| Comp. Ex. 8 | 0.5 | 3.6 | 3.2 |
| Comp. Ex. 9 | 0.4 | 3.0 | 42.6 |

<Measurement Methods of Average Major Axis and Average Aspect Ratio of Crystalline Polyester>

The average major axis and average aspect ratio of the crystalline polyester resin of the toner were measured by the following methods.

The toner was embedded in a visible light-curable embedding resin (D-800, available from Nissin EM Co., Ltd.). The resin was then sliced into a 60 nm-thick piece by means of an ultrasonic ultramicrotome (EMS, available from Leica Microsystems). The cut piece was dyed with Ru using a vacuum electron staining apparatus (available from Filgen, Inc.). Thereafter, the dyed cut piece was observed under a transmissive electron microscope (H7500, available from Hitachi, Ltd.) at acceleration voltage of 120 kV. For the observation of the toner, 50 particles having the particle diameters that were within ±2.0 micrometers from the weight average particle diameter were selected and the images thereof were captured. In case of the configuration of the present disclosure, as a result of the RuO₄ dying, the color contrast of the polyester resin in the toner appears dark. In the case where wax is used, the wax appears even darker. The average major axis and average aspect ratio of the domains formed of the polyester resin C can be determined from the observed image, but the average aspect ratio can be calculated using image processing software.

As the image processing software, Image-Pro Plus 5.1J (available from MediaCybernetics) was used. The cross-sectional image of the toner particles captured by the above-described method was used. In order to extract the toner particles to be analyzed, first, the toner particle sections were selected to separate the toner particles from the background. “Measurement”−“Count/Size” of Image-Pro Plus 5.1J was selected. From the window of “Count/Size,” “Measurement”−“Measuring Item” was selected. From the measuring items, “Diameter (Minimum)” and “Diameter (Maximum)” were selected. For “Luminance Range Selection,” the luminance range needed to be adjusted to select only the polyester resin A. It was necessary to adjust the luminance range for each measurement depending on the conditions of RuO₄ dying, but the polyester resin A was easily determined from the above-described color contrast (shading). “Count” was selected to display the measurement results. Thereafter, an aspect ratio (major axis/minor axis) could be determined using the obtained “Diameter (Minimum)” as the minor axis, and “Diameter (Maximum)” as the major axis. From the data of the aspect ratio of one toner particle obtained in the above-described manner, an average value of 10 values selected in the order from the largest diameter (maximum) was determined. The determination of the average value was repeated on 10 toner particles to determine an average value of the aspect ratio.

<Measurement Method of Carbon Radioisotope ¹⁴C Concentration>

The carbon radioisotope ¹⁴C concentration of the toner was measured according to radiocarbon dating. The toner was burned to reduce carbon dioxide (CO₂) thereof to obtain graphite (C). The ¹⁴C concentration of the graphite (C) was measured by means of an accelerator mass spectrometer (AMS, available from Beta Analytic).

<Evaluations>

The following evaluations were performed on the obtained toners. The results are presented in Table 7.

«Carbon neutrality»

Carbon neutrality was evaluated based on the carbon radioisotope ¹⁴C concentration of the toner.

(Evaluation Criteria)
A: 40.0 pMC or greater
B: 20.0 pMC or greater but less than 40.0 pMC
C: 5.4 pMC or greater but less than 20.0 pMC
D: less than 5.4 pMC

«Low Temperature Fixability»

The carrier used in IMAGIO MP C5503 (available from Ricoh Company Limited) and the above-obtained toner were blended in a manner that the concentration of the toner was to be 5% by mass, to thereby obtain [Developer 1].

After charging the unit of IMAGIO MP C5503 (available from Ricoh Company Limited) with [Developer 1], a rectangular solid image in the size of 2 cm ×15 cm was formed on PPC sheet Type 6000<70W> A4 long grain paper (available from Ricoh Company Limited) with the toner deposition amount of 0.40 mg/cm². During the formation of the solid image, the surface temperature of the fixing roller was varied. Whether cold offset occurred or not was observed to evaluate low temperature fixability. The cold offset is a phenomenon that a development residual image is fixed on an area other than a desired area.

(Evaluation Criteria)
A: 110° C. or lower
B: 110° C. or higher but lower than 120° C.
C: 120° C. or higher but lower than 130° C.
D: 130° C. or higher

<Cleaning Evaluation>

The carrier used in IMAGIO MP C5503 (available from Ricoh Company Limited) and the above-obtained toner were blended in a manner that the concentration of the toner was to be 5% by mass, to thereby obtain a developer. The unit of IMAGIO MP C5503 (available from Ricoh Company Limited) was charged with the developer, and an image having an imaging area ratio of 30% was developed, and the developed image was transferred onto transfer paper. Thereafter, the toner remained on the photoconductor after transferring the developed image was cleaned by the cleaning blade. In the middle of the cleaning, the photocopier was stopped, and the toner remained on the photoconductor after passing through the cleaning was transferred onto white paper with SCOTCH TAPE (available from 3M Japan Limited). The resultant was measured at 10 points by means of Macbeth RD514 reflection densitometer. A difference between the average value of the 10 measurement values and the measurement result when a tape was simply adhered to blank paper was determined, and the result was evaluated based on the following criteria.

The used cleaning blade was a cleaning blade which had been used for printing of 20,000 sheets.

(Evaluation Criteria)
A: The difference was 0.010 or less.
B: The difference was greater than 0.010 but 0.012 or less.
C: The difference was greater than 0.012 but 0.015 or less.
D: The difference was greater than 0.015.

The evaluation results are presented in Table 7.

TABLE 7

| | Carbon | | Low temperature |
|---|---|---|---|
| | neutrality | Cleaning | fixability |
| Ex. 1 | A | C | A |
| Ex. 2 | A | B | B |
| Ex. 3 | B | A | C |
| Ex. 4 | B | C | A |
| Ex. 5 | C | C | A |
| Ex. 6 | C | B | A |
| Ex. 7 | C | A | C |
| Ex. 8 | C | C | A |
| Ex. 9 | B | A | A |
| Ex. 10 | B | C | A |
| Comp. Ex. 1 | A | A | D |
| Comp. Ex. 2 | C | A | D |
| Comp. Ex. 3 | B | A | D |
| Comp. Ex. 4 | B | D | B |
| Comp. Ex. 5 | A | C | D |
| Comp. Ex. 6 | D | D | B |
| Comp. Ex. 7 | C | A | D |
| Comp, Ex. 8 | D | A | D |
| Comp. Ex. 9 | A | A | D |

The present disclosure is directed to the toner according to (1), but the present disclosure also includes embodiments according to the following (2) to (16).
(1) Resin particles each including:
a crystalline polyester resin;
an amorphous polyester resin;
a release agent; and
a colorant,

wherein the crystalline polyester resin includes an acid component and an alcohol component as constitutional units, and the acid component of the crystalline polyester resin includes plant-derived dicarboxylic acid having 12 or less carbon atoms,

wherein the crystalline polyester resin is present as domains in a matrix of the amorphous polyester resin within each resin particle, an average major axis of the domains of the crystalline polyester resin is 2.0 micrometers or less, and an average aspect ratio (major axis/minor axis) of the domains is 4.0 or greater, and

wherein the resin particles have a carbon radioisotope ¹⁴C concentration of 5.4 pMC or greater.
(2) The resin particles according to (1), wherein the carbon radioisotope ¹⁴C concentration is 20.0 pMC or greater.
(3) The resin particles according to (1) or (2), wherein the carbon radioisotope ¹⁴C concentration is 40.0 pMC or greater.
(4) The resin particles according to any one of (1) to (3), wherein the amorphous polyester resin includes an acid component and an alcohol component as constitutional units, and the acid component of the amorphous polyester resin includes plant-derived succinic acid or plant-derived sebacic acid.
(5) The resin particles according to any one of (1) to (4), wherein the alcohol component of the crystalline polyester resin includes diol having 8 or less carbon atoms.
(6) The resin particles according to any one of (1) to (5), wherein the alcohol component of the crystalline polyester resin includes 1,6-hexanediol, 1,8-octanediol, or plant-derived ethylene glycol.
(7) The resin particles according to any one of (1) to (6), wherein the release agent is vegetable wax, or ester wax formed from a plant-derived material.
(8) Resin particles for a toner, including the resin particles according to any one of (1) to (7).
(9) A toner including the resin particles for a toner according to (8).
(10) The toner according to (9), further including external additives added to the resin particles for a toner.
(11) A method for producing resin particles, the method including:
(a) dissolving or dispersing at least a crystalline polyester resin, an amorphous polyester resin, and a colorant in an organic solvent to prepare an oil phase;
(b) adding water to the oil phase to invert a phase from a water in oil dispersion liquid to an oil in water dispersion liquid; and
(c) aggregating particles in the oil in water dispersion liquid to produce the resin particles according to any one of (1) to (8), wherein a release agent is added during the step (a) or (c).
(12) A method for producing resin particles, the method including:
(a) dissolving or dispersing at least an amorphous polyester resin and a colorant in an organic solvent to prepare an oil phase;
(b) adding water to the oil phase to invert a phase from a water in oil dispersion liquid to an oil in water dispersion liquid;
(c) adding a crystalline polyester resin to the oil in water dispersion liquid to aggregate particles in the oil in water dispersion liquid to produce the resin particles according to any one of (1) to (8), wherein a release agent is added during the step (a) or (c).
(13) A method for producing a toner, the method including adding external additives to the resin particles produced by the method according to (11) or (12).
(14) A developer including:
the toner according to (9) or (10); and a carrier.
(15) A toner storage unit including:
a unit; and
the toner according to (9) or (10) stored in the unit.
(16) An image forming apparatus including:
an electrostatic latent image bearer;
an electrostatic latent image forming unit configured to form an electrostatic latent image on the electrostatic latent image bearer; and
a developing unit that stores a toner and is configured to develop the electrostatic latent image formed on the electrostatic latent image bearer with the toner to form a visible image,
wherein the toner is a toner according to (9) or (10).

### REFERENCE SIGNS LIST

10: photoconductor, photoconductor drum, latent electrostatic image bearing member
10K: electrostatic latent image bearer for black
10Y: electrostatic latent image bearer for yellow
10M: electrostatic latent image bearer for magenta
10C: electrostatic latent image bearer for cyan
14: supporting roller
15: supporting roller
16: supporting roller
17: intermediate transfer member cleaning device
18: image forming unit
20: charging device (charging roller)
21: exposure device
22: secondary transferring device
23: roller
24: secondary transfer belt
25: fixing device
26: fixing belt
27: pressure roller
28: sheet reverser
30: exposure device
32: contact glass
33: first carriage
34: second carriage
35: image forming lens
36: reading sensor
40: developing device
41: developing belt
42K: developer storage unit
42Y: developer storage unit
42M: developer storage unit
42C: developer storage unit
43K: developer supply roller
43Y: developer supply roller
43M: developer supply roller
43C: developer supply roller
44K: developing roller
44Y: developing roller
44M: developing roller
44C: developing roller
45K: black developing unit
45Y: yellow developing unit
45M: magenta developing unit
45C: cyan developing unit
49: registration roller
50: intermediate transfer member
51: roller
52: separation roller
53: manual paper feeding path
54: manual feeding tray
55: separation craw
56: ejecting roller
57: paper ejection tray
58: corona charger
60: cleaning device
61: developing device
62: transfer charger
63: photoconductor cleaning device
64: charge-eliminating device
70: charge-eliminating lamp
80: transfer roller
90: cleaning device
95: transfer paper
100A, 100B, 100C: image forming apparatus
110: process cartridge
120: tandem developing device
130: document table
142: paper feeding roller
143: paper bank
144: paper feeding cassette
145: separation roller
146: paper feeding path
147: conveying roller
148: paper feeding path
150: photocopier main body
160: charging device
200: paper feeding table
300: scanner
400: automatic document feeder (ADF)
L: exposure light
a: toner base particle (resin particle)
b: crystalline polyester resin
c: amorphous polyester resin

1. Resin particles, each comprising:
a crystalline polyester resin
an amorphous polyester resin
a release agent and
a colorant,
wherein the crystalline polyester resin includes an acid component and an alcohol component as constitutional units, and the acid component of the crystalline polyester resin includes plant-derived dicarboxylic acid having 12 or less carbon atoms,
wherein the crystalline polyester resin is present as domains in a matrix of the amorphous polyester resin within each resin particle, an average major axis of the domains of the crystalline polyester resin is 2.0 micrometers or less, and an average aspect ratio (major axis/minor axis) of the domains is 4.0 or greater, and
wherein the resin particles have a carbon radioisotope ¹⁴C concentration of 5.4 OK or greater.

2. The resin particles according to claim 1,
wherein the carbon radioisotope ¹⁴C concentration is 20.0 pMC or greater.

3. The resin particles according to claim 1,
wherein the carbon radioisotope ¹⁴C concentration is 40.0 pMC or greater,

4. The resin particles according to claim 1, wherein the amorphous polyester resin includes an acid component and an alcohol component as constitutional units, and the acid component of the amorphous polyester resin includes plant-derived succinic acid or plant-derived sebacic acid.

5. The resin particles according to claim 1, wherein the alcohol component of the crystalline polyester resin includes diol having 8 or less carbon atoms.

6. The resin particles according to claim 1, wherein the alcohol component of the crystalline polyester resin includes 1,6-hexanediol, 1,8-octanediol, or plant-derived ethylene glycol.

7. The resin particles according to claim 1, wherein the release agent is vegetable wax, or ester wax formed from a plant-derived material.

8. A toner, comprising:
the resin particles according to claim 1; and
external additives added to the resin particles.

9. A method for producing resin particles, the method comprising:
(a) dissolving or dispersing at least a crystalline polyester resin, an amorphous polyester resin, and a colorant in an organic solvent to prepare an oil phase;
(h) adding water to the oil phase to invert a phase from a water in oil dispersion liquid to an oil in water dispersion liquid; and
(c) aggregating particles in the oil in water dispersion liquid to produce the resin particles according to claim 1,
wherein a release agent is added during the step (a) or (c).

10. A method for producing resin particles, the method comprising:
(a) dissolving or dispersing at least an amorphous polyester resin and a colorant in an organic solvent to prepare an oil phase;
(b) adding water to the oil phase to invert a phase from a water in oil dispersion liquid to an oil in water dispersion liquid;
(c) adding a crystalline polyester resin to the oil in water dispersion liquid to aggregate particles in the oil in water dispersion liquid to produce the resin particles according to claim 1,
wherein a release agent is added during the step (a) or (c).

11. A method for producing a toner, the method comprising:
adding external additives to the resin particles produced by the method according to claim 9.

12. A developer, comprising:
the toner according to claim 8; and
a carrier.

13. A toner storage unit, comprising:
a unit; and
the toner according to claim 8 stored in the unit.

14. An image forming apparatus, comprising:
an electrostatic latent image bearer;
an electrostatic latent image forming unit configured to form an electrostatic latent image on the electrostatic latent image bearer; and
a developing unit that stores a toner and is configured to develop the electrostatic latent image formed on the electrostatic latent image bearer with the toner to form a visible image,
wherein the toner is a toner according to claim 8.
